(19) United States
(12) Patent Application Publication
(10) Pub. No.: US 2013/0212349 A1
(43) Pub. Date: Aug. 15, 2013

(54) LOAD THRESHOLD CALCULATING APPARATUS AND LOAD THRESHOLD CALCULATING METHOD

(71) Applicant: FUJITSU LIMITED, (US)

(72) Inventor: Tetsutaro MARUYAMA, Kawasaki (JP)

(21) Appl. No.: 13/693,176

(22) Filed: Dec. 4, 2012

(30) Foreign Application Priority Data
Feb. 13, 2012 (JP) 2012-028934

(51) Int. Cl. G06F 12/00

(52) U.S. Cl. CPC G06F 12/00
USPC 711/167

(57) ABSTRACT

A load threshold calculating apparatus includes a computer that acquires for a second storage device having a lower response performance to access requests than a first storage device, a required maximum response time for response to a read request; substitutes the maximum response time into a model expressing for the second storage device, a response time to the read request, the response time increasing exponentially with an increase in read requests and according to an exponent denoting the number of read requests to the second storage device per unit time, to calculate a value indicative of the number of read requests in a case of the maximum response time; calculates based on the calculated value and the number of the memory areas in the second storage device, an upper limit value of the number of read requests to a memory area per unit time; and outputs the upper limit value.

### CROSS REFERENCE TO RELATED APPLICATIONS

This application is based upon and claims the benefit of priority of the prior Japanese Patent Application No. 2012-028934, filed on Feb. 13, 2012, the entire contents of which are incorporated herein by reference.

### FIELD

The embodiment discussed herein is related to an evaluation support program, a load threshold calculating apparatus and a load threshold calculating method.

### BACKGROUND

Tiered storage has conventionally been known as a technique for improving storage response to access, such as read requests and write requests, and for reducing the operation costs of the storage. Tiered storage combines storage media of differing performance, such as a solid state drive (SSD), serial attached SCSI (SAS), and a nearline (NL)-SAS.

With tiered storage, frequently accessed data is stored in a faster, more expensive storage medium, such as SSD, while less accessed data is stored in a slower, less expensive storage medium, such as NL-SAS, and thereby, realizes faster reading and writing of frequently accessed data and an overall reduction in operation cost.

Each set of storage media differing in performance is called a “tier”, and the tiered storage is composed of, for example, three tiers including SSD, SAS, and NL-SAS. The tier to which user data is to be assigned in the tiered storage is determined by, for example, setting a capacity ratio of each tier.

For example, a case is assumed where capacity ratios with respect to the entire memory capacity of the tiered storage is set as 10[%] for the SSD, 30[%] for the SAS, and 60[%] for the NL-SAS. In this case, for example, among the data, the top 10% most frequently accessed data is assigned to the SSD, the next 30% most frequently accessed data is assigned to the SAS, and the remaining 60% of the data is assigned to the NL-SAS.

According to a related prior technique, for example, data is rearranged and stored to multiple types of hierarchized data storage media (hereinafter “prior technique 1”). According to prior technique 1, when data is rearranged among data storage media in different tiers or storage media in the same tier, according to the characteristics of each storage medium and the characteristics of data to be stored, one of multiple rearrangement strategies is selected to rearrange the data.

Another known technique enables power consumption in a storage system having multiple large-capacity memory devices (hereinafter “prior technique 2”). According to prior technique 2, data blocks having a data access frequency that exceeds a specified upper limit are transferred to a memory device in a high-performance group and data blocks having a data access frequency below a specified lower limit are transferred to a memory device in a low-performance group.

For examples of the conventional techniques, refer to Japanese Laid-Open Patent Publication Nos. H9-44381 and 2003-108317.

The conventional techniques, however, pose a problem in that determining the tier to which data should be assigned is difficult. For example, assigning data using the capacity ratios set for each tier risks the occurrence of contention among users of the tiered storage with respect to a high-performance tier, such as SSD and SAS.

### SUMMARY

According to an aspect of an embodiment, a computer-readable recording medium stores a program causing a computer to execute a load threshold calculating process that includes acquiring for a second storage device, a required maximum response time for response to a read request, the second storage device having a lower response performance to an access request that represents a read request or write request than a first storage device; substituting the acquired maximum response time into a response model expressing for the second storage device, a response time for response to the read request, the response time increasing exponentially with an increase in the number of read requests and according to an exponent denoting the number of read requests to the second storage device per unit time, to calculate a value indicative of the number of read requests in a case of the maximum response time; calculating based on the calculated value indicative of the number of read requests and on the number of the memory areas in the second storage device, an upper limit value of the number of read requests to a memory area per unit time; and outputting the calculated upper limit value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of one example of a load threshold according to an embodiment;

FIG. 2 is an explanatory diagram of an example of a configuration of a tiered storage system 200;

FIG. 3 is a block diagram of a hardware configuration of a load threshold calculating apparatus 100 according to the embodiment;

FIG. 4 is an explanatory diagram of an example of device information;

FIG. 5 is an explanatory diagram of an example of load information;

FIG. 6 is a block diagram of an example of a functional configuration of the load threshold calculating apparatus 100;

FIG. 7 is an explanatory diagram of an example of a definition of multiplicity;

FIG. 8 is an explanatory diagram of a probability distribution of IOPS per Sub-LUN of the tiered storage system 200;

FIGS. 9, 10, and 11 are explanatory diagrams of examples of load threshold calculation screens;

FIG. 12 is a flowchart of one example of a load threshold calculating procedure by the load threshold calculating apparatus 100;

FIG. 13 is a flowchart of an example of a procedure of a response model generating process;

FIG. 14 is a flowchart of an example of a procedure of a tier 1/tier 2 upper TOPS threshold calculating process;

FIG. 15 is a flowchart of an example of a procedure of a tier 1/tier 2 lower IOPS threshold calculating process;

FIG. 16 is a flowchart of an example of a procedure of a screen generating process by the load threshold calculating apparatus 100; and

FIG. 17 is a flowchart of an example of an operation procedure by the load threshold calculating apparatus 100.

### DESCRIPTION OF EMBODIMENTS

Preferred embodiments of the present invention will be explained with reference to the accompanying drawings.

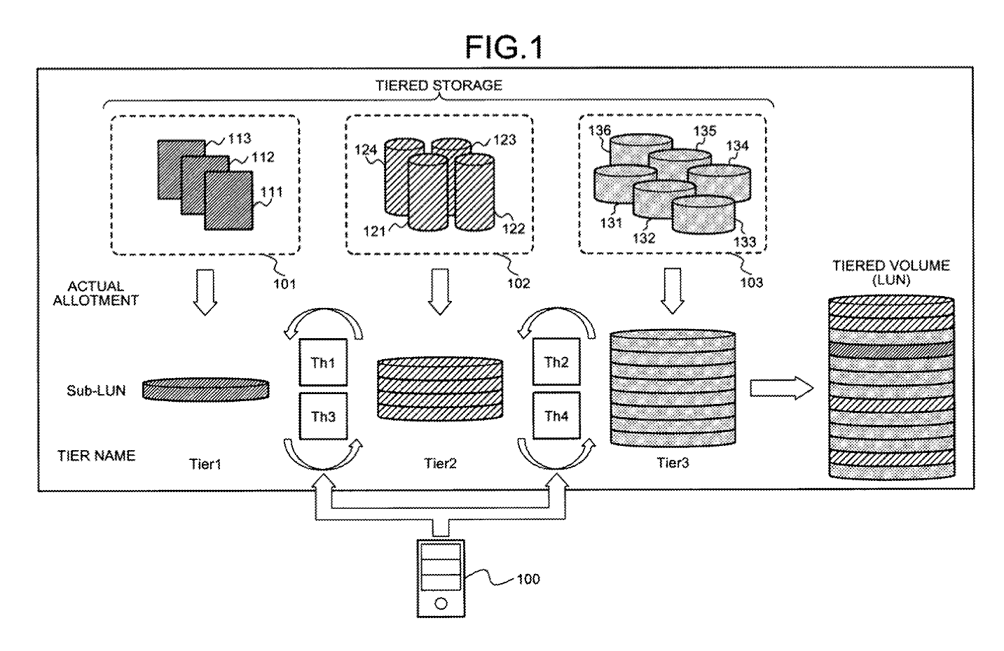

FIG. 1 is an explanatory diagram of one example of a load threshold according to an embodiment. In FIG. 1, a load threshold calculating apparatus 100 is a computer that assists in assigning data to multiple storage devices (storage devices 101 to 103 in FIG. 1).

The storage devices 101 to 103 are a set of storage media differing in response performance with respect to input/output (I/O) requests, and each having one or more memory devices. The I/O requests are access requests, such as read requests and write requests, to the storage devices 101 to 103. Response performance is, for example, an average response time to an I/O request.

The memory device is, for example, a hard disk, magnetic tape, optical disk, flash memory, etc. For example, the storage device 101 has memory devices 111 to 113. The storage device 102 has memory devices 121 to 124. The storage device 103 has memory devices 131 to 136.

The storage devices 101 to 103 are, for example, the devices implemented by redundant arrays of independent disks (RAID) 1, 5, 6, etc., affording data redundancy to improve resistance against failure.

The memory devices 111 to 113 are, for example, SSDs, and have higher response performance to I/O requests than the memory devices 121 to 124 and the memory devices 131 to 136. The memory devices 121 to 124 are, for example, SASs, and have higher response performance to I/O requests than the memory devices 131 to 136. The memory devices 131 to 136 are, for example, NL-SASs.

The storage devices 101 to 103 respectively differing in response performance to I/O requests are combined to make up tiered storage composed of three tiers. The storage device 101 is defined as a tier 1, the storage device 102 is defined as a tier 2, and the storage device 103 is defined as a tier 3.

The memory area of each of the storage devices 101 to 103 is divided into submemory areas each having a given memory capacity, and each submemory area is allotted according to a volume used by a user. In the following description, submemory areas, into which the memory area of each of the storage devices 101 to 103 is divided, may be written as “Sub-LUNs”. A volume used by the user is a volume in which a data group accessed by the user is stored, and is referred to as a logical unit number (LUN). Hence, LUNs represent tiered volumes managed in units of Sub-LUNs. When multiple users use the tiered storage, the assignment of data using the capacity ratios set for each tier risks the occurrence of contention among users contend for a high-performance tier, such as SSD and SAS. If a user does not know a proper capacity ratio to be set for each tier, for example, the user ends up setting an theoretically inferred capacity ratio or a capacity ratio entirely bound by the configuration of the tiered storage. These cases may make it impossible to enjoy the advantages of improved access response performance and reduced operation costs afforded by tiered storage.

According to the embodiment, the load threshold calculating apparatus 100 calculates a load threshold for the load on each tier, to serve as an index for determining to which tier, storage data is to be assigned. In the example of the tiered storage composed of three tiers depicted in FIG. 1, the load threshold calculating apparatus 100 calculates, for example, four kinds of load thresholds Th1, Th2, Th3, and Th4.

The load threshold Th1 is the threshold for identifying a Sub-LUN in the tier 2 to be transferred from the tier 2 to the tier 1. The Sub-LUNs of the tier 2 are submemory areas which are created by dividing the storage device 102 of the tier 2 and are allotted as LUNs.

Transfer of a Sub-LUN means transfer of data stored in a Sub-LUN of a given tier to a Sub-LUN of another tier, i.e., switching a Sub-LUN as a data assignment destination in a storage device of a given tier to a Sub-LUN of a storage device of another tier. For example, the transfer of a Sub-LUN involves a series of processes of establishing an unused Sub-LUN in a transfer destination tier, copying data stored in a Sub-LUN in a transfer origin tier to the established Sub-LUN, and releasing the Sub-LUN in the transfer origin tier.

A load can be represented as input output per second (IOPS) indicating the number of I/O requests issued in 1 second. The load threshold calculating apparatus 100, for example, calculates the load threshold Th1 enabling a determination that the Sub-LUN in the tier 2 has the required response performance, when an IOPS representing a load applied to a Sub-LUN in the tier 2 is below the load threshold Th1.

In other words, the load threshold Th1 is a value enabling a determination that the Sub-LUN in the tier 2 should be transferred to the tier 1, when the IOPS representing the load applied to the Sub-LUN in the tier 2 exceeds the load threshold Th1.

The load threshold Th2 is a threshold for identifying a Sub-LUN in the tier 3 that is to be transferred to the tier 2. The load threshold calculating apparatus 100, for example, calculates the load threshold Th2 enabling a determination that the Sub-LUN in the tier 3 has the required response performance, when an IOPS representing a load applied to a Sub-LUN in the tier 3 is below the load threshold Th2.

In other words, the load threshold Th2 is a value enabling a determination that the Sub-LUN in the tier 3 should be transferred to the tier 2, when the IOPS representing the load applied to the Sub-LUN in the tier 3 exceeds the load threshold Th2.

The load threshold Th3 is a threshold for identifying a Sub-LUN in the tier 1 that is to be transferred to the tier 2. The load threshold calculating apparatus 100, for example, calculates the load threshold Th3 enabling a determination that a transfer of the Sub-LUN to the tier 2 enables I/O requests to be processed with optimal performance, when an IOPS representing a load applied to a Sub-LUN in the tier 1 is below the load threshold Th3.

The load threshold Th4 is a threshold for identifying a Sub-LUN in the tier 2 that is to be transferred to the tier 3. The load threshold calculating apparatus 100, for example, calculates the load threshold Th4 enabling a determination that a transfer of the Sub-LUN to the tier 3 enables I/O requests to be processed with optimal performance, when an IOPS representing a load applied to a Sub-LUN in the tier 2 is below the load threshold Th4.

The thresholds TH1, Th2, Th3, and Th4 enable a Sub-LUN having an increasing access frequency to be transferred to a higher tier and a Sub-LUN having a decreasing access frequency to be transferred to a lower tier, according to the utilization state of each Sub-LUN.

For example, according to the load threshold Th1, a Sub-LUN having a Sub-LUN IOPS exceeding the load threshold Th1 can be transferred from the tier 2 to the tier 1. According to the load threshold Th2, a Sub-LUN having a Sub-LUN IOPS exceeding the load threshold Th2 can be transferred from the tier 3 to the tier 2.

According to the load threshold Th3, a Sub-LUN having a Sub-LUN IOPS below the load threshold Th3 can be transferred from the tier 1 to the tier 2. According to the load threshold Th4, a Sub-LUN having a Sub-LUN IOPS exceeding the load threshold Th4 can be transferred from the tier 2 to the tier 3.

In this manner, the load threshold calculating apparatus 100 calculates a load threshold for each Sub-LUN in each tier of the tiered storage, whereby a Sub-LUN that should be transferred from one tier to another can be identified, thereby enabling efficient support in the assignment of data to each tier.

An example of a configuration of a tiered storage system that combines storage media differing in response performance to I/O requests will be described.

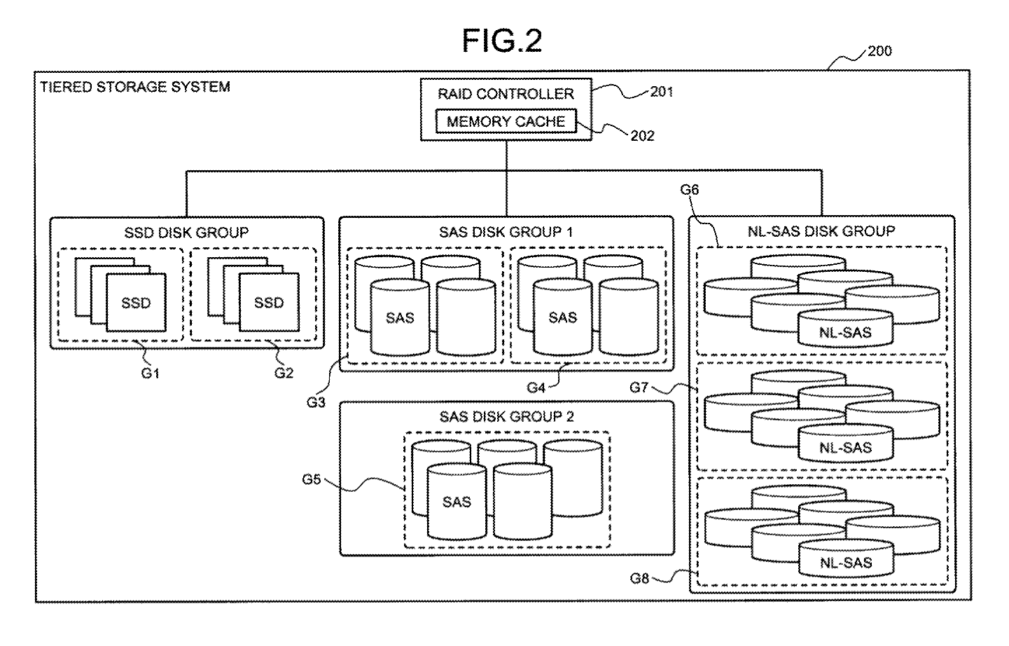

FIG. 2 is an explanatory diagram of an example of a configuration of a tiered storage system 200. In FIG. 2, the tiered storage system 200 includes a RAID controller 201 and RAID groups G1 to G8. The RAID controller 201 controls access to the RAID groups G1 to G8.

The RAID controller 201 has a memory cache 202, which temporarily stores data read out from the RAID groups G1 to G8 or data to be written to the RAID groups G1 to G8.

Each of the RAID groups G1 to G8 represents one logical memory device created by combining multiple memory devices using a RAID 5 configuration. For example, each of the RAID groups G1 and G2 is a RAID group of three SSDs and has a RAID rank of “2”. The RAID rank represents the number of memory devices making up the RAID group. In the case of RAID 5, the RAID rank represents, for example, the number of data disks among a group of hard disks (or a group of slices) including several data disks (or data slices) and one parity disk (or parity slice).

Each of the RAID groups G3 and G4 is a RAID group of four SASs and has a RAID rank of “3”. The RAID groups G5 is a RAID group of five SASs and having a RAID rank of “4”. Each of the RAID groups G6 to G8 is a RAID group including six NL-SASs and has a RAID rank of “5”.

RAID groups identical in the type of memory devices and the RAID rank are grouped into a frame called disk pool. For example, the RAID groups G1 and G2 are grouped into an SSD disk pool. The RAID groups G3 and G4 are grouped into an SAS disk pool 1. The RAID group G5 is grouped into an SAS disk pool 2. The RAID groups G6 and G8 are grouped into an NL-SAS disk pool. When the user uses the tiered storage system 200, the user specifies three types of disk pools for three tiers, respectively.

In the following description, it is assumed that only one RAID group is present in each disk pool. In the tiered storage system 200, the SSD disk pool is defined as the tier 1, the SAS disk pool 1 and the SAS disk pool 2 are defined as the tier 2, and the NL-SAS disk pool is defined as the tier 3. While it has been stated that the tiered storage system 200 has one RAID controller 201, the tiered storage system 200 may have multiple RAID controllers.

The RAID groups G1 to G8 are, for example, equivalent to the storage devices 101 to 103 of FIG. 1. Memory devices making up the RAID groups G1 to G8 are, for example, equivalent to the memory devices 111 to 113, 121 to 124, and 131 to 136. The load threshold calculating apparatus 100 of FIG. 1 may be applied to the tiered storage system 200.

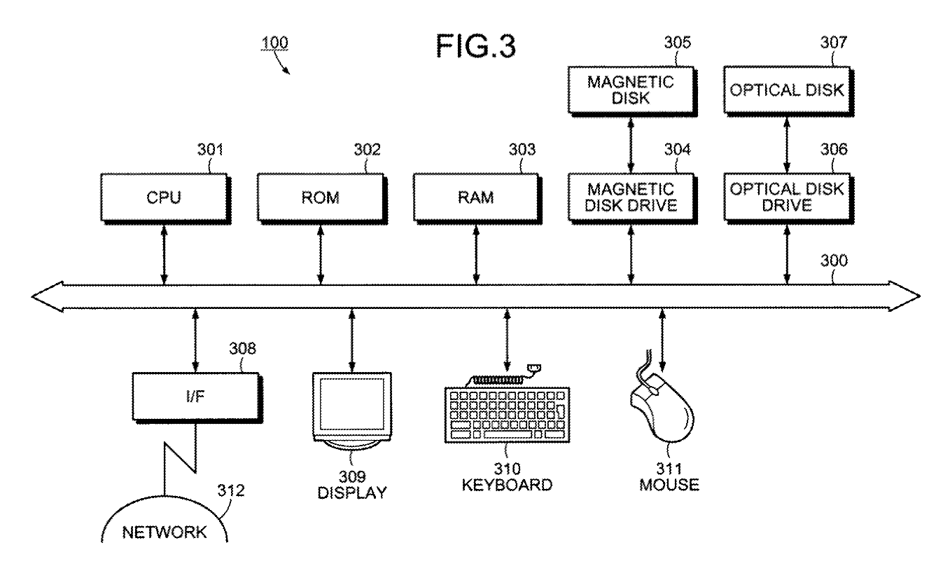

FIG. 3 is a block diagram of a hardware configuration of the load threshold calculating apparatus 100 according to the embodiment. As depicted in FIG. 3, the load threshold calculating apparatus 100 includes a central processing unit (CPU) 301, a read-only memory (ROM) 302, a random access memory (RAM) 303, a magnetic disk drive 304, a magnetic disk 305, an optical disk drive 306, an optical disk 307, an interface (I/F) 308, a display 309, a keyboard 310, and a mouse 311, respectively connected by a bus 300.

The CPU 301 governs overall control of the load threshold calculating apparatus 100. The ROM 302 stores therein programs such as a boot program. The RAM 303 is used as a work area of the CPU 301. The magnetic disk drive 304, under the control of the CPU 301, controls the reading and writing of data with respect to the magnetic disk 305. The magnetic disk 305 stores therein data written under control of the magnetic disk drive 304.

The optical disk drive 306, under the control of the CPU 301, controls the reading and writing of data with respect to the optical disk 307. The optical disk 307 stores therein data written under control of the optical disk drive 306, the data being read by a computer.

The I/F 308 is connected to a network 312 such as a local area network (LAN), a wide area network (WAN), and the Internet through a communication line and is connected to other apparatuses through the network 312. The I/F 308 administers an internal interface with the network 312 and controls the input/output of data from/to external apparatuses. For example, a modem or a LAN adaptor may be employed as the I/F 308.

The display 309 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 309.

The keyboard 310 includes, for example, keys for inputting letters, numerals, and various instructions and performs the input of data. Alternatively, a touch-panel-type input pad or numeric keypad, etc. may be adopted. The mouse 311 is used to move the cursor, select a region, or move and change the size of windows. In addition to the configuration above, the load threshold calculating apparatus 100 may further include, for example, a scanner and a printer.

An example of device information used by the load threshold calculating apparatus 100 will be described. Device information is, for example, information concerning the tiered storage system 200.

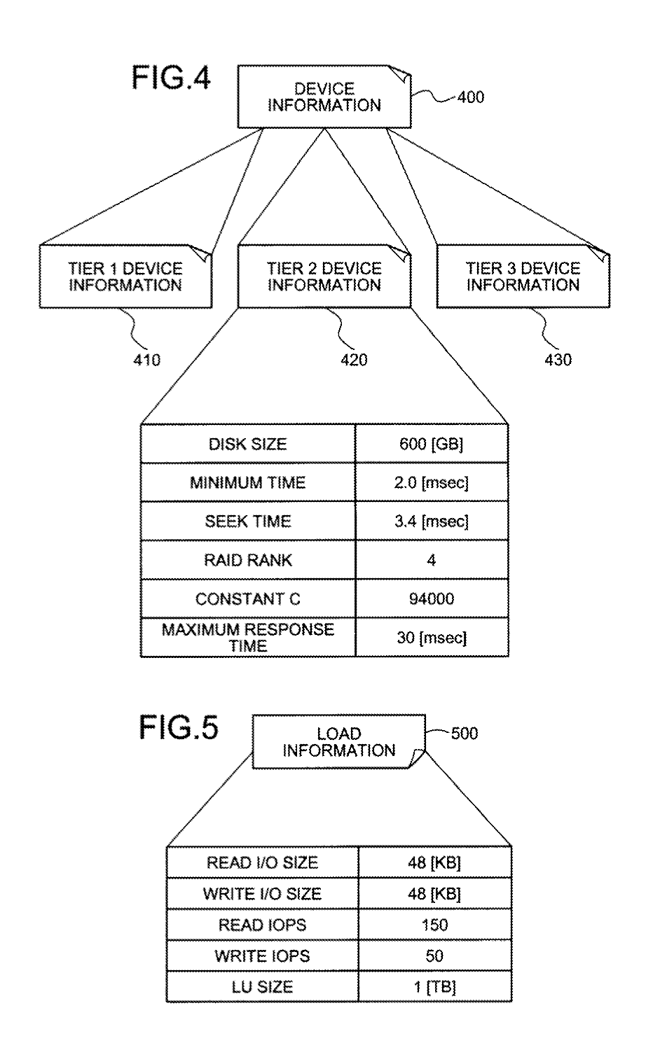

FIG. 4 is an explanatory diagram of an example of device information. In FIG. 4, device information 400 includes tier 1 device information 410, tier 2 device information 420, and tier 3 device information 430 concerning the tiered storage system 200. For example, the tier 1 device information 410 indicates a disk size, a minimum time, a seek time, a RAID rank, a constant C, and a maximum response time of the RAID group in the tier 1 of the tiered storage system 200.

The tier 2 device information 420 indicates a disk size, a minimum time, a seek time, a RAID rank, a constant C, and a maximum response time of the tier 2 RAID group of the tiered storage system 200. The tier 3 device information 430 indicates a disk size, a minimum time, a seek time, a RAID rank, a constant C, and a maximum response time of the tier 3 RAID group of the tiered storage system 200.

The disk size (hereinafter “disk size (D)”) represents the memory capacity of each of memory devices making up a RAID group in each tier. The minimum time (hereinafter “minimum time (L)”) represents an average of minimum times that memory devices making up a RAID group of each tier take to respond to a read request. For example, the minimum time (L) is a time yielded by subtracting a seek time and a data transfer time from the period between reception of an I/O request and completion of data input/output.

The seek time (hereinafter “seek time (S)”) represents an average of seek times that memory devices making up a RAID group of each tier take. The RAID rank (hereinafter “RAID rank (R)”) represents the number of data disks among a group of hard disks including several data disks and one parity disk.

The constant C is the constant included in a response model to be described later, and is a value peculiar to each RAID group. The maximum response time (hereinafter “maximum response time (Wₘₐₓ)”) is an index for determining whether the response performance of an RAID group in response to a read request in each tier is the required response performance. The maximum response time (Wₘₐₓ), for example, is set to a value allowing a determination that when a response time to a read request is below the maximum response time (Wₘₐₓ), response performance is sufficient in terms of required response performance. The values of the minimum time (L) and seek time (S) may be determined as values released by manufacturers that sell memory devices, such as SSDs, SASs, and NL-SASs.

For example, the tier 2 device information 420 indicates the disk size (D) as “D=600 [GB]”, the minimum time (L) as “L=2.0 [msec]”, the seek time (S) as “S=3.4 [msec]”, the RAID rank (R) as “R=4”, the constant C as “C=84000”, and the maximum response time (Wₘₐₓ) as “Wₘₐₓ=30 [msec]”.

In the following description, the maximum response time (Wₘₐₓ) of the tier 3 of the tiered storage system 200 may be indicated as “Wₘₐₓ=40 [msec]”, which will not depicted. Because the tier 1 is the uppermost tier of the tiered storage system 200, the tier 1 device information 410 may omit the maximum response time (Wₘₐₓ).

An example of load information used by the load threshold calculating apparatus 100 will be described. Load information is, for example, information indicating a load applied to the RAID group of each tier of the tiered storage system 200. Load information indicating a load applied to the RAID group of the tier 2 of the tiered storage system 200 will be described as an example.

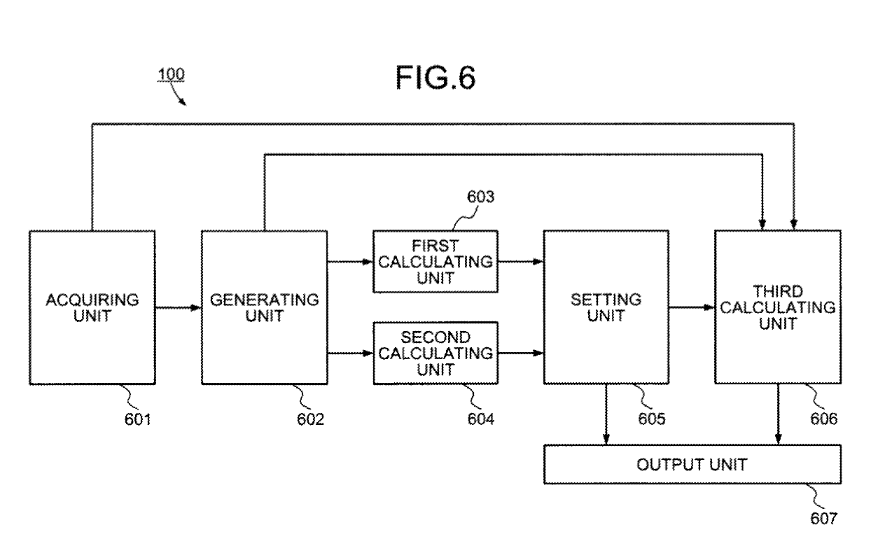

FIG. 5 is an explanatory diagram of an example of load information. In FIG. 5, load information 500 indicates a READ I/O size, a WRITE I/O size, a READ IOPS, a WRITE IOPS, and a logical unit (LU) size.

The READ I/O size represents an average volume of data that is read out when a read request is issued, i.e., the average I/O size of a read request. The WRITE I/O size represents an average volume of data that is written when a write request is issued, i.e., the average I/O size of a write request.

The READ IOPS represents the average number of read requests issued in 1 second. The Write IOPS represents the average number of write requests issued in 1 second. The LU size represents the memory capacity of a LUN allotted to the user using the tiered storage system 200.

In the following description, READ I/O size may be written as “I/O size (r [symbol] [symbol] )”, WRITE I/O size may be written as “I/O size (r_{W})”, READ IOPS may be written as “IOPS (X_{R})”, and WRITE IOPS may be written as “IOPS (X_{W})”.

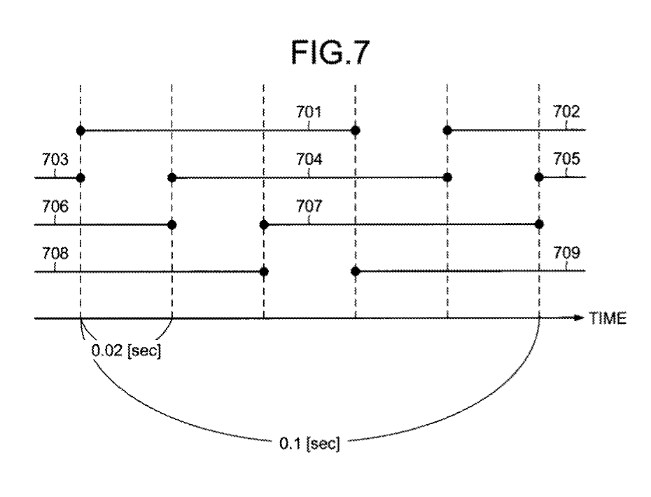

An example of a functional configuration of the load threshold calculating apparatus 100 will be described. FIG. 6 is a block diagram of an example of a functional configuration of the load threshold calculating apparatus 100. In FIG. 6, the load threshold calculating apparatus 100 includes an acquiring unit 601, a generating unit 602, a first calculating unit 603, a second calculating unit 604, a setting unit 605, a third calculating unit 606, and an output unit 607. The acquiring unit 601 to the output unit 607 are functional units serving as a control unit, and are realized by, for example, causing the CPU 301 to execute programs stored in the memory devices of FIG. 3, such as the ROM 302, the RAM 303, the magnetic disk 305, and the optical disk 307, or through the I/F 308. Results obtained by each functional unit is stored in, for example, a memory device such as RAM 303, magnetic disk 305, and optical disk 307.

The acquiring unit 601 has a function of acquiring device information concerning a group of storage devices differing in response performance to I/O requests. This group of storage devices differing in response performance to I/O requests makes up a so-called tiered storage, which is, for example, the tiered storage system 200 of FIG. 2.

In the following description, multiple tiers making up the tiered storage may be written as “tier 1 to tier m” (In denotes a natural number greater than or equal to 2), and an arbitrary tier among the tier 1 to tier m may be written as “tier j” (j=1, 2, . . . , m).

The device information, for example, includes a disk size (D), a RAID rank (R), a seek time (S), a constant C included in a response model to be described later, and a maximum response time (W [symbol] [symbol] max) of the RAID group of each tier of the tiered storage.

For example, the acquiring unit 601 acquires the device information 400 of FIG. 4 through user input via the keyboard 310 or the mouse 311. The acquiring unit 601 may acquire the device information 400 from the tiered storage system 200 via, for example, the network 312.

The acquiring unit 601 also has a function of acquiring load information indicating a load applied to the RAID group of each tier of the tiered storage. The load information includes, for example, the I/O size (r_{R}) and IOPS (X_{R}) of a read request to the RAID group, the I/O size (r_{W}) and IOPS (X_{W}) of a write request, and the LU size of a LUN.

For example, the acquiring unit 601 acquires the load information 500 of FIG. 5 through user input via the keyboard 310 or mouse 311. The acquiring unit 601 may acquire the load information 500 from an external computer via, for example, the network 312.

The generating unit 602 has a function of generating a response model indicating an average response time of the RAID group of the tier 1 of the tiered storage, for response to read requests. A response model is a function representing an average response time that increases exponentially with an increase in the IOPS of a read request, the IOPS being an exponent of the function.

The response model to be generated is expressed as equation (1), where W denotes an average response time to read requests and is expressed in, for example, [msec], X denotes the average TOPS of read requests to the RAID group, α [symbol] c denote an exponential factor, and T [symbol] min denotes a minimum response time of the RAID group for response to a read request.

W=e^{α}^{ₑ}^{X}+Tₘᵢₙ−1 (1)

Equation (1) is derived from, for example, a statistical examination of the result of a load experiment of the RAID group. The contents of a process by the generating unit 602 will be described later.

The first calculating unit 603 has a function of calculating a load threshold representing an upper limit value of the average IOPS of I/O requests to a Sub-LUN in a RAID group of a tier j (hereinafter “upper IOPS threshold (Xᵤₚ)”). Sub-LUN is a management unit representing a submemory area created by dividing the memory area of the RAID group. Each Sub-LUN has the same memory capacity.

The upper IOPS threshold (Xᵤₚ) is the load threshold for transferring a Sub-LUN having a Sub-LUN IOPS exceeding the upper IOPS threshold (Xᵤₚ), from the tier j to a tier (j−1) having response performance to I/O requests higher than that of the tier j. Thus, the upper IOPS threshold (Xᵤₚ) is calculated for each Sub-LUN in the RAID groups of the tiers given by excluding the uppermost tier 1 from the tier 1 to tier m of the tiered storage.

A case is described where assuming a RAID group is in the worst condition in terms of performance, the upper IOPS threshold (Xᵤₚ) is calculated under the following presupposed (condition 1), (condition 2), and (condition 3).

(Condition 1) Each Sub-LUN in the RAID group is allotted as a LUN of any one of users using the tiered storage system 200. (Condition 2) A load is applied to each Sub-LUN in the RAID group. (Condition 3) Each I/O request to the RAID group is a random I/O request, which is an I/O request that points to discontinuous locations.

For example, the first calculating unit 603 substitutes the acquired maximum response time (W [symbol] max) of the RAID group of the tier j into equation (1) to calculate the average IOPS of read requests in a case of an average response time (W) for response to a read request being the maximum response time (W [symbol] max). In the following description, the average IOPS of read requests in the case of the average response time (W) for response to a read request being the maximum response time (W [symbol] max) is written as “IOPS (X_{Rup})”.

IOPS (X_{Rup}) represents the average IOPS of read requests in the case of the response performance of the RAID group of the tier j in response to a read request being sufficient as required response performance. This means that if the IOPS (X_{R}) representing a load applied to the RAID group is less than the IOPS (X_{Rup}), it can be determined that the RAID group has response performance sufficient as the required response performance.

In other words, when the IOPS (X_{R}) representing a load applied to the RAID group exceeds the IOPS (X_{Rup}), a determination can be made that it is better to transfer any one of Sub-LUNs in the RAID group from the tier j to the tier (j−1) having higher response performance to I/O requests than the tier j.

The first calculating unit 603 may calculate the upper IOPS threshold (Xᵤₚ) representing the upper limit value to the average IOPS of I/O requests to a Sub-LUN, by dividing the calculated IOPS (X_{Rup}) by the number of Sub-LUNs in the RAID group. As a result, when the average response time (W) for response to a read request is the maximum response time (W [symbol] max), the average IOPS of read requests representing a load applied to a Sub-LUN can be calculated as the upper IOPS threshold (Xᵤₚ).

The above IOPS (X_{Rup}) is the IOPS calculated by considering only the read requests among I/O requests to the RAID group of the tier j. Thus, the first calculating unit 603 may calculate the average IOPS of I/O requests made up of read requests and write requests mixed together, using equation (2).

In equation (2), X [symbol] Tup denotes the average IOPS of I/O requests made up of read requests and write requests mixed together (hereinafter “IOPS (X [symbol] Tup)”), and c denotes a read request mixed ratio, which represents the ratio of the IOPS of read requests to the IOPS of I/O requests made up of both read requests and write requests.

The read request mixed ratio can be expressed, for example, as equation (3) (o<c≦), where XR denotes the average IOPS of read requests to the RAID group and XW denotes the average IOPS of write requests to the RAID group.

X [symbol] Tup=X [symbol] Rup/c (2)

c=x [symbol] /(x [symbol] +x [symbol] ) (3)

The first calculating unit 603 may calculate the upper IOPS threshold (Xᵤₚ) for the tier j, by dividing the calculated IOPS (X [symbol] Tup) by the number of Sub-LUNs in the RAID group. As a result, when the average response time (W) for response to a read request is the maximum response time (W [symbol] max), the average IOPS of read requests representing a load applied to a Sub-LUN can be calculated as the upper IOPS threshold (Xᵤₚ). The contents of the process by the first calculating unit 603 will be described later.

The second calculating unit 604 has a function of calculating a load threshold representing a lower limit value of the average IOPS of I/O requests to a Sub-LUN in a RAID group of a tier (j−1) (hereinafter “lower IOPS threshold (X_{down})”). The lower IOPS threshold (X_{down}) is the load threshold for transferring a Sub-LUN having a Sub-LUN IOPS below the lower IOPS threshold (X_{down}), from the tier (j−1) to a tier j having response performance to I/O requests less than that of the tier (j−1).

Thus, the lower IOPS threshold (X_{down}) is calculated for each Sub-LUN in the RAID groups of the tiers given by excluding the lowermost tier from the tier 1 to tier m of the tiered storage. A case is described where assuming a RAID group is in the worst condition in terms of its performance, the lower IOPS threshold (X_{down}) is calculated under the above presupposed (condition 1), (condition 2), and (condition 3).

For example, the lower IOPS threshold (X_{down}) is the load threshold for transferring to a lower tier, a Sub-LUN that is expected to process I/O requests at optimum processing performance if transferred to a lower tier. “load under which a Sub-LUN can process I/O requests at optimum processing performance” is defined as “multiplicity identical with an RAID rank”.

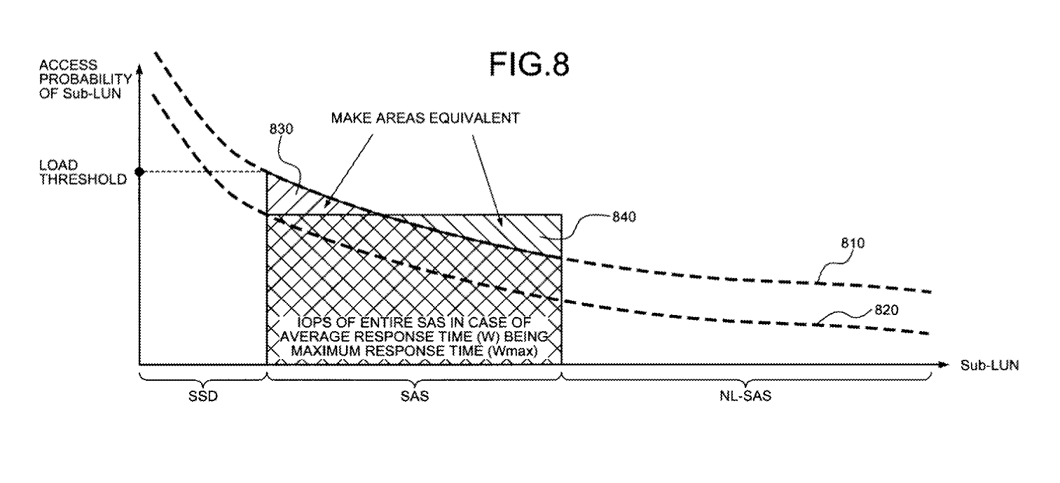

Multiplicity represents the number of I/O request processing time slots overlapping in a unit time. This multiplicity serves as, for example, an index for assessing the response performance of the RAID group. Multiplicity will be described in detail later with reference to FIG. 7.

For example, when the multiplicity of each data disk of the RAID group is less than “1”, optimizing a seek time through an elevator algorithm is impossible. The processing performance of the data disk, therefore, deteriorates. When the multiplicity of each data disk of the RAID group is greater than “1”, a process waiting time in queuing arises. Hence, the processing performance of the data disk deteriorates, too.

This means that each data disk of the RAID group can process I/O requests at highest processing performance when the multiplicity of each data disk is “1”. The RAID group, therefore, can process I/O requests at optimum processing performance when the multiplicity of the RAID group is identical with the RAID rank of the same, provided that the I/O size (r_{R}) is less than or equal to the stripe size of the RAID. In the following description, the multiplicity identical with the RAID rank of the RAID group is written as “safe multiplicity (N_{safe})”.

For example, the second calculating unit 604 calculates the average IOPS of read requests in a case of the multiplicity of the RAID group of the tier j being the safe multiplicity (N_{safe}), using equation (4) based on Little's law of the queuing theory. In the following description, the average IOPS of read requests in the case of the multiplicity of the RAID group being the safe multiplicity (N_{safe}) may be written as “IOPS (X_{Rdown})”.

In equation (4), N denotes multiplicity, X denotes an IOPS, and W denotes an average response time for response to an I/O request. An average response time for response to a read request in the case of the multiplicity of the RAID group being the safe multiplicity (N_{safe}) (hereinafter “average response time (W_{Rdown})”) is expressed using, for example, equation (1).

N−X×W (4)

The IOPS (X_{Rdown}) represents the average TOPS of read requests in the case of the RAID group of the tier j being able to process I/O requests at optimum process performance. When the IOPS ( [symbol] XR) representing a load applied to the RAID group of the tier (j−1) is below the IOPS (X_{Rdown}), a determination can be made that it is better to transfer any one of Sub-LUNs in the RAID group of the tier (j−1) from the tier (j−1) to the tier j having lower response performance to I/O requests than the tier (j−1).

The second calculating unit 604 may calculate the lower IOPS threshold (X_{down}) for the tier (j−1), by dividing the calculated IOPS (X_{Rdown}) by the number of Sub-LUNs in the RAID group of the tier j. As a result, the average IOPS of read requests representing a load applied to a Sub-LUN in the case of the multiplicity of the RAID group of the tier j being the safety multiplicity (N_{safe}) can be calculated as the lower IOPS threshold (X_{down}) for the tier (j−1).

The above IOPS (X_{Rdown}) is the TOPS calculated by considering only the read requests among I/O requests to the RAID group of the tier j. For this reason, the second calculating unit 604 may calculate the average IOPS of I/O requests made up of read requests and write requests mixed together, using equation (5), where X_{Rdown} denotes the average IOPS of I/O requests made up of read request and write requests mixed together (hereinafter “IOPS (X [symbol] Tdown)”) and c denotes a read request mixed ratio.

X [symbol] Tdown=X [symbol] Rdown/c (5)

The second calculating unit 604 may calculate the lower LOPS threshold (X_{down}) for the tier (j−1), by dividing the calculated IOPS (X [symbol] Tdown) by the number of Sub-LUNs in the RAID group. As a result, the average IOPS of I/O requests representing a load applied to a Sub-LUN in the case of the multiplicity of the RAID group of the tier j being the safety multiplicity (N_{safe}) can be calculated as the lower IOPS threshold (X_{down}) for the tier (j−1). The contents of the process by the second calculating unit 604 will be described later.

The setting unit 605 has a function of setting the calculated upper IOPS threshold (Xᵤₚ) for the tier j as the upper IOPS threshold for a Sub-LUN in the RAID group of the tier j. The setting unit 605 may set the calculated lower IOPS threshold (X_{down}) for the tier (j−1) as the lower IOPS threshold for a Sub-LUN in the RAID group of the tier (j−1).

When the lower IOPS threshold (X_{down}) for the tier (j−1) is greater than the upper IOPS threshold (Xᵤₚ) for the tier j, the setting unit 605 may set the upper IOPS threshold (Xᵤₚ) for the tier j as the lower IOPS threshold for the tier (j−1), thereby preventing a reverse situation where the IOPS of a Sub-LUN in the tier j is greater than the IOPS of a Sub-LUN in the (j−1) tier.

The third calculating unit 606 has a function of calculating the capacity ratio (CRj) of the RAID group of the tier j based on a setting result. The capacity ratio (CRj) represents, for example, the ratio of the memory capacity of a Sub-LUN allotted from the RAID group of the tier j to a LUN, to the memory capacity of the LUN used by the user.

For example, the third calculating unit 606 calculates the capacity ratio (CRj) of the RAID group of the tier j in a case of transferring a Sub-LUN between different tiers according to the upper IOPS threshold (Xᵤₚ) and/or lower IOPS threshold (X_{down}) set for each tier.

Based on the setting result, the third calculating unit 606 may calculate an average response time of the RAID group of the tier j for response to an I/O request. For example, the third calculating unit 606 calculates the average response time of the RAID group of the tier j fpr response to an I/O request in the case of transferring a Sub-LUN between different tiers according to the upper IOPS threshold (Xᵤₚ) and/or lower IOPS threshold (X_{down}) set for each tier. The contents of the process by the third calculating unit 606 will be described later.

The output unit 607 has a function of outputting a setting result. For example, the output unit 607 stores the output result in such memory devices as the RAM 303, magnetic disk 305, and optical disk 307, displays the output result on the display 309, prints out the output result on the printer, or transmits the output result to an external apparatus through the I/F 308.

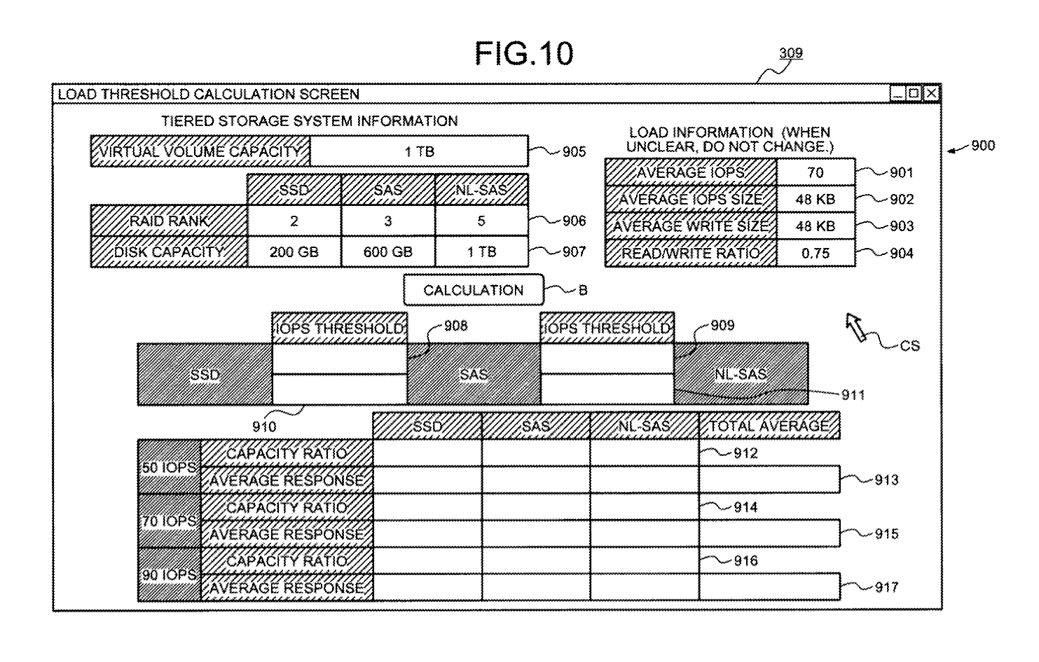

The output unit 607 may output the calculated capacity ratio (CRj) of the RAID group of the tier j and may output the calculated average response time of the RAID group of the tier j for response to an I/O request. Examples of output result screens will be described later with reference to FIGS. 9 to 11.

The multiplicity serving as an index for assessing the response performance of the RAID group of each tier of the tiered storage will be described.

FIG. 7 is an explanatory diagram of an example of a definition of the multiplicity. FIG. 7 depicts processing time slots 701 to 709 for processing I/O requests in a case of parallel processing of I/O requests to an RAID group. For example, a black circle on the left end of the processing time slot 701 represents a point in time at which an I/O request has been received, while a black circle on the right end represents a point in time at which a response to the I/O request has been sent back.

In this example, the multiplicity is defined as the average number of I/O request processing time slots overlapping per second. In this case, the multiplicity can be calculated using equation (4) based on Little's law of the queuing theory.

In the example of FIG. 7, an I/O request arises every 0.02. [sec]. The IOPS is, therefore, “50”. A response time to each I/O request is 0.06 [sec]. An average response time to I/O requests is, therefore, “0.06 [sec]”. Hence, the multiplicity is given by equation (4) as “N=3=50×0.06”.

The multiplicity represents an extent to which processing time slots overlap each other when I/O requests are processed in parallel with each other simultaneously, that is, represents the length of a queue in which the I/O requests are placed. It can be concluded, therefore, that the greater the multiplicity is, the greater loads applied to the RAID group are. Hence the multiplicity serves as an index for assessing the response performance of the RAID group. In the following description, multiplicity of a given value N may be written as “multiplicity (N)”.

The contents of the process by the generating unit 602 will be described. A case of generating a response model will be described, where the response model expresses an average response time of the RAID group of the j tier of the tiered storage for response to read requests.

The generating unit 602 calculates the maximum IOPS (X_{N}) of the RAID group of the tier j in a case of the multiplicity (N). The maximum IOPS (X_{N}) is the maximum number of read requests that the RAID group can process in a unit time in the case of the multiplicity (N), representing the RAID group's maximum process performance in its processing of read requests.

For example, the generating unit 602 can calculate the maximum IOPS (X_{N}) of the RAID group in the case of the multiplicity (N), using equation (6), where X_{N} denotes the maximum IOPS in the case of the multiplicity (N), C denotes a constant peculiar to the RAID group in the case of the multiplicity (N), r_{R} denotes the average I/O size of read requests, which is expressed in, for example, [KB], R denotes the RAID rank of the RAID group, and v denotes a use ratio representing a ratio of an actually used memory area to the entire memory area of the RAID group.

X_{N}=C×{1/(r_{R}+64)}×R^{0.5} [symbol] ×(v+0.5)^{-0.5} (6)

Equation (6) is derived from, for example, a statistical examination of the result of a load experiment of the RAID group. An example of calculation of the maximum IOPS (X₃₀) of the RAID group of the tier 2 of the tiered storage system 200 in a case of the multiplicity (30) will be described, using the tier 2 device information 420 of FIG. 4 and the load information 500 of FIG. 5.

The values of elements necessary for calculating the maximum IOPS (X₃₀) of the RAID group in the case of multiplicity (30) are as follows, where the use rate v of the RAID group is set to 1 according to the above (condition 1).

Constant C: C=94000

RAID rank (R): R=4
I/O size (r_{R}): 48 [KB]
Use rate (v): v=1

The generating unit 602 substitutes the values of the constant C, I/O size (r_{R}), RAID rank (R), and use rate (v) into equation (6) to calculate the maximum IOPS (X₃₀) of the storage device 102 in the case of multiplicity (30). This calculation gives “the maximum IOPS (X₃₀)=639.115”.

Based on the multiplicity (N) and the maximum IOPS (X [symbol] ) of the RAID group in the case of multiplicity (N), the generating unit 602 calculates a response time (W [symbol] ) of the RAID group for response to a read request. For example, the generating unit 602 can calculate the average response time (W [symbol] ) for response to a read request, using equation (4).

For example, the generating unit 602 substitutes the calculated maximum IOPS (X₃₀) and the multiplicity (30) into equation (4) to calculate a response time (W₃₀) for response to a read request. When the maximum IOPS (X₃₀) “X₃₀=639.115” is given to equation (4), the response time (W₃₀) is calculated as “W₃₀=46.94 [msec]=30×1000/X₃₀”. Because Little's law determines a value in units of [sec], the calculated value is multiplied by 1000 to be expressed in units of [msec].

The generating unit 602 then calculates a minimum response time (Tₘᵢₙ) of the RAID group for response to a read request. The minimum response time (Tₘᵢₙ) represents an average response time for response to a read request in a case of the IOPS representing a load applied to the RAID group being 0. In other words, the minimum response time (Tₘᵢₙ) represents an average response time for response to a read request in a case of the multiplicity being “0”.

For example, based on acquired device information and load information, the generating unit 602 can calculate the minimum response time (Tₘᵢₙ) for response to a read request using equation (7), where Tₘᵢₙ denotes the minimum response time of the RAID group for response to a read request, L denotes an average of minimum times that memory devices making up the RAID group take to respond to read requests, S denotes an average seek time of the memory devices making up the RAID group, v denotes the use ratio representing the ratio of an actually used memory area to the entire memory area of the RAID group, and r, denotes the average I/O size of read requests to the RAID group.

Tₘᵢₙ=L+S×(v+0.5)^{0.5}+0.12r_{R} (7)

Equation (7) is derived from, for example, a statistical examination of the result of a load experiment of the RAID group. An example of calculation of the minimum response time (Tₘᵢₙ) of the RAID group of the tier 2 of the tiered storage system 200 will be described, using the tier 2 device information 420 and the load information 500. The values of elements necessary for calculating the minimum response time (Tₘᵢₙ) are as follows.

Minimum time (L): L=2.0 [msec]

Seek time (S): S=3.4 [msec]
Use rate (v): v=1
I/O size (r [symbol] ): r=48 [KB]

The generating unit 602 substitutes the values of the minimum time (L), seek time (S), use rate (v), and I/O size (r [symbol] ) into equation (7) to calculate the minimum response time (Tₘᵢₙ) of the RAID group. This calculation gives “the minimum response time (Tₘᵢₙ)=0.005785”.

Based on the calculated response time (W_{N}), maximum IOPS (X [symbol] ), and minimum response time (Tₘᵢₙ), the generating unit 602 makes a response model expressing an average response time (W) of the RAID group for response to a read request.

For example, the generating unit 602 substitutes the values of the response time (W_{N}), the maximum IOPS (X_{N}), and the minimum response time (Tₘᵢₙ) into equation (8) to calculate an exponential factor (α1) for the response model. The exponential factor (α1) is the exponential factor in a case of a read request mixed rate (hereinafter “read request mixed rate (c)”) being 1. In other words, the exponential factor (α1) is the exponential factor in a case of neglecting the presence of write requests to the RAID group.

W_{N}=e^{α}^{₁}^{X}^{_{N}}+Tₘᵢₙ−1 (8)

The generating unit 602 calculates an exponential factor (α [symbol] c) for a response model in a case of read requests and write requests being mixed together, that is, a case of the read request mixed rate (c) being “c≠0”. In the case of read requests and write requests being mixed together, the average response time (W), which increases exponentially with an increase in the IOPS (X), increases more sharply than the case of neglecting the presence of write requests. This means that when read requests and write requests are mixed together, the value of the exponential factor included in the response model becomes greater, compared to when the presence of write requests is neglected.

For example, the generating unit 602 can calculate the exponential factor (α [symbol] c) for the response model in the case of the read request mixed rate being “c”, using equation (9), where c denotes the read request mixed rate, which can be expressed as, for example, equation (3), α [symbol] c denotes the exponential factor in the case of the read request mixed rate being “c” (“c≠0”), and α [symbol] 1 denotes the exponential factor in the case of the read request mixed rate being “1”.

In equation (9), t denotes an I/O size ratio (hereinafter “I/O size ratio (t)”), which represents the ratio of the I/O size (r_{W}) to the I/O size (r_{R}). The I/O size ratio (t) can be expressed as, for example, equation (10).

$$\begin{matrix}{α}_{c} = \frac{exp \{ 1.6 {t}^{0.16} ( 1 - c ) {e}^{c} \}}{{c}^{1 - c}} {α}_{1} & ( 9 ) \\ t = {r}_{w} / {r}_{g} & ( 10 )\end{matrix}$$

Equation (9) is derived from, for example, a statistical examination of the result of a load experiment of the RAID group. An example of generating a response model in the case of the multiplicity being (30) for the RAID group of the tier 2 of the tiered storage system 200 will be described, using the tier 2 device information 420 and the load information 500. The values of elements necessary for generating the response model are as follows.

Maximum IOPS (X₃₀): X₃₀=639.115

Minimum response time (Tₘᵢₙ): Tₘᵢₙ=5.615
Average response time (W₃₀): W₃₀=46.94
IOPS (x_{R}): x_{R}=150
IOPS (x_{W}): x_{W}=50
I/O size (r_{R}): r_{R}=48 [KB]
I/O size (r_{W}): r_{W}=48 [KB]

The generating unit 602 substitutes the average response time (W₃₀), the maximum IOPS (X₃₀), and the minimum response time (Tₘᵢₙ) into equation (8) to calculate the exponential factor (α₁). The exponential factor (α₁) is calculated as “α₁=0.005785”.

The generating unit 602 substitutes the IOPS (X_{R}) and IOPS (X_{W}) into equation (3) to calculate the read request mixed rate (c). The read request mixed rate (c) is calculated as “c=0.75”. The generating unit 602 also substitutes the I/O size (r_{R}) and the I/O size (r_{W}) into equation (10) to calculate the I/O size ratio (t). The I/O size ratio (t) is calculated as “t=1”.

The generating unit 602 substitutes the read request mixed rate (c), the I/O size ratio (t), and the exponential factor (α₁) into equation (9) to calculate the exponential factor (α [symbol] c) for the response model in the case of the read request mixed rate being “c”. The exponential factor (α [symbol] c) is calculated as “α [symbol] c=0.0014496”.

The generating unit 620 substitutes the calculated exponential factor (α [symbol] c) and minimum response time (Tₘᵢₙ) into equation (1) and thereby, generates a response model expressing the average response time (W) of the RAID group for response to a read request.

The contents of the process by the first calculating unit 603 will be described. First, a probability distribution of the IOPS per Sub-LUN of the tiered storage system 200 will be described by taking the tiered storage system 200 of FIG. 2 as an example.

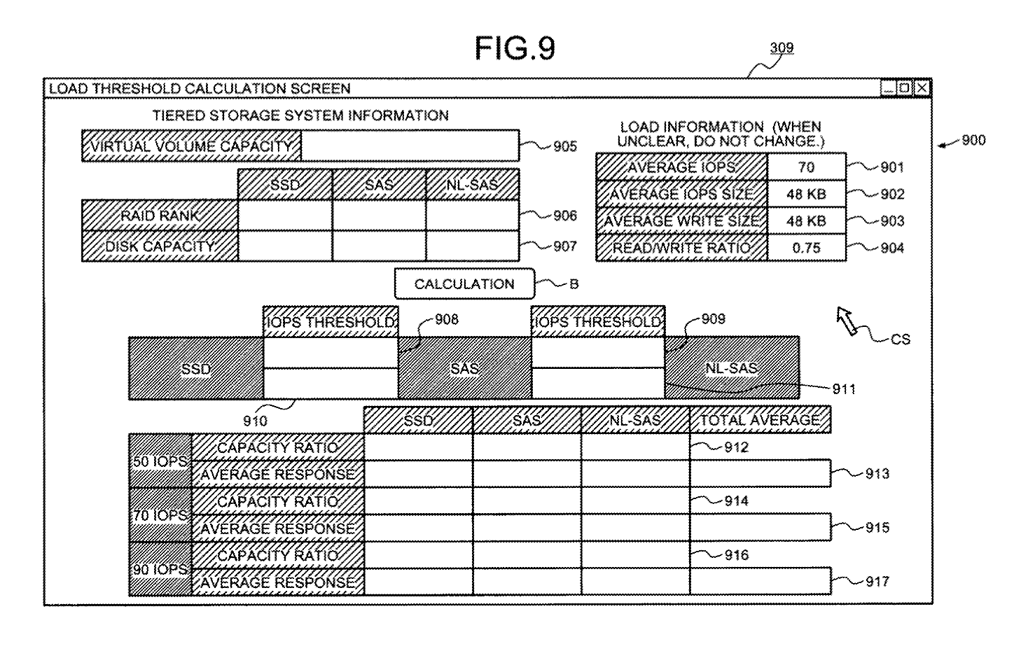

FIG. 8 is an explanatory diagram of a probability distribution of the IOPS per Sub-LUN of the tiered storage system 200. In FIG. 8, a probability distribution 810 represents probabilities of Sub-LUNs of the tiered storage system 200 being accessed. The probabilities are sorted in the order of sizes of the IOPSs of Sub-LUNs of the tiered storage system 200.

When the IOPSs of Sub-LUNs are sorted in the order of sizes of the IOPSs, the probability distribution 810 is assumed to follow the pattern of the Zipf distribution. The Zipf distribution is a probability distribution that follows the Zipf's law according to which the rate of an element k-th highest in appearance frequency to the entire set of elements is proportional to 1/k.

As a result, when a value given by dividing the IOPS (X [symbol] Tup) by the number of Sub-LUNs in the RAID group is determined to be the upper IOPS threshold (Xᵤₚ), the total IOPS of the RAID group of the tier j turns out to be less than an assumed IOPS. For example, a probability distribution 820 represents a probability distribution that is assumed to result when the value given by simply dividing the IOPS (X [symbol] Tup) by the number of Sub-LUNs in the RAID group is determined to be the upper IOPS threshold (Xᵤₚ).

Assuming that the probability distribution expressed by sorting the IOPSs of Sub-LUNs of the tiered storage in the order of size of the IOPSs follows the pattern of the Zipf distribution, therefore, the first calculating unit 603 calculates the upper IOPS threshold (Xᵤₚ) so that an IOPS representing a load applied to the tier j is the IOPS (X [symbol] Tup). In FIG. 8, for example, the first calculating unit 603 calculates the upper IOPS threshold (Xᵤₚ) so that an area 830 becomes equal to an area 840. The contents of the process executed by the first calculating unit 603 to calculate the upper IOPS threshold (Xᵤₚ) for the tier j will be described.

The first calculating unit 603 calculates the number of Sub-LUNs (hereinafter “number of Sub-LUNs (n)” in the tier j. For example, the first calculating unit 603 can calculate the number of Sub-LUNs (n) of the tier j using equation (11).

In equation (11), n denotes the number of Sub-LUNs of the j tier, Q denotes a ratio of the memory area given by excluding a system area from the memory area of the RAID group of the tier j (hereinafter “ratio (Q)”) to the entire memory area of the RAID group of the tier j, D denotes the disk size of the RAID group of the tier j, R denotes the RAID rank of the RAID group of the tier j, and d denotes a Sub-LUN size representing the memory capacity of each Sub-LUN.

n=(Q×D×R)/d (11)

The Sub-LUN size (d) is preset and is stored in the memory devices, such as the ROM 302, RAM 303, magnetic disk 305, and optical disk 307. For example, the Sub-LUN size (d) is “1.3 [GB]”.

In the following description, the number of Sub-LUNs of the tier j may be written as “number of Sub-LUNs (nⱼ)”, and the sum of the number of Sub-LUNs of the tier 1 to tier m of the tiered storage may be written as “total number of Sub-LUNs (N)”.

For example, when the Sub-LUN size (d) is “1.3 [GB]”, the number of Sub-LUNs (n₂) of the tier 2 of the tiered storage system 200 is calculated as “n₂≈1230”, the number of Sub-LUNs (n₁) of the tier 1 is calculated as “n₁≈280”, and the number of Sub-LUNs (n:) of the tier 3 is calculated as “n₃≈430”. In this case, the total, number of Sub-LUNs (N) is calculated as “N=4940”.

The first calculating unit 603 calculates the sum of probabilities (Pj) of Sub-LUNs of the tier j being accessed. In the case of sorting the IOPSs of Sub-LUNs of the tiered storage in the order of size of the IOPS, a probability (xᵢ) of the i-th Sub-LUN being accessed can be expressed using, for example, equation (12), where x; denotes a probability of the i-th Sub-LUN being accessed and N denotes the total number of Sub-LUNs of the tiered storage.

$${x}_{i} = \frac{\frac{1}{i}}{{\sum }_{i = 1}^{N} \frac{1}{i}} \qquad ( 12 )$$

Hence, the first calculating unit 603 can calculate the sum of probabilities (Pj) of Sub-LUNs of the tier j being accessed, using equation (13), where Pj denotes the sum of probabilities of Sub-LUNs of the tier j being accessed, a denotes a value given by adding “1” to the sum of the number of Sub-LUNs of the tier 1 to tier (j−1), that is, when the IOPSs of Sub-LUNs of the tiered storage are sorted in the order of the size of IOPSs, “a” denotes the order of a Sub-LUN with the maximum probability of being accessed among Sub-LUNs of the tier j, and b denotes the sum of the number of Sub-LUNs of the tier 1 to tier j.

Pj=Σᵢ₌ₐ^{b}xᵢ (13)

The first calculating unit 603 calculates the IOPS of the a-th Sub-LUN in the case of an IOPS representing a load applied to the tier j being the IOPS (X [symbol] Tup), as the upper IOPS threshold (Xᵤₚ), using equation (14), where Xᵤₚ denotes the upper IOPS threshold for the tier j, X [symbol] up denotes the average IOPS of read requests in the case of the average response time (W) of the RAID group of the j tier for response to a read request being the maximum response time (Wₘₐₓ), X [symbol] denotes an access probability of a Sub-LUN with the maximum probability of being accessed among Sub-LUNs of the tier j, and Pj denotes the sum of Sub-LUNs of the tier j being accessed.

Xᵤₚ=X [symbol] up×x [symbol] /Pj (14)

An example of calculation of the upper IOPS threshold (Xᵤₚ) for the RAID group will be described by taking the tier 1 and tier 2 of the tiered storage system 200 as an example. The values of elements necessary for calculating the upper IOPS threshold (Xᵤₚ) are as follows.

Maximum response time (Wₘₐₓ): Wₘₐₓ=30 [msec]

Number of Sub-LUNs (n1): n1≈280
Number of Sub-LUNs (n2): n1≈1230

In this case, the first calculating unit 603 first substitutes the maximum response time (Wₘₐₓ) of the RAID group of the tier j into equation (1) to calculate the IOPS (X_{Rup}), at which the minimum response time (Tₘᵢₙ) is set to “0.005785” and the exponential factor (α [symbol] c) is set to “0.0014496”. As a result, the IOPS (X_{Rup}) is calculated as “X_{Rup}=223.1”.

The first calculating unit 603 substitutes the IOPS (X_{Rup}) into equation (2) to calculate the IOPS (X [symbol] Tup), at which the read request mixed rate (c) is step to “0.75”. As a result, the IOPS (X_{Rup}) is calculated as “X_{Rup}=297.467”.

The first calculating unit 603 calculates the sum of probabilities (P2) of Sub-LUNs of the tier 2 being accessed, using equation (13). The sum of probabilities (P2) is calculated as “P2=0.187”, which is indicated by equation (15). An access probability (x₂₈₁) of the 281-th Sub-LUN with the maximum probability of being accessed among Sub-LUNs of the tier 2 is calculated as “x₂₈₁=0.0004”.

P2=Σᵢ₌₂₈₁²⁸⁰⁺¹²³⁰xᵢ=0.187 (15)

The first calculating unit 603 substitutes the values of the IOPS (X [symbol] Tup), access probability (x₂₈₁), and sum of probabilities (P2) into equation (14) to calculate the upper IOPS threshold (Xᵤₚ) for the tier 2. In this example, the upper IOPS threshold (Xᵤₚ) is calculated as “Xᵤₚ=0.633”.

While the access probability X [symbol] is defined as the access probability of the Sub-LUN with the maximum probability of being accessed among Sub-LUNs of the tier j in the above explanation, the access probability X [symbol] may be defined as the access probability of another Sub-LUN. For example, the access probability X [symbol] may be defined as the access probability of a Sub-LUN with the second or third largest probability of being accessed among Sub-LUNs of the tier j if the defined access probability is regarded as an equivalent to the maximum access probability.

Calculating the upper IOPS threshold (Xᵤₚ) for the RAID group of the tier 3 of the tiered storage system 200 merely requires replacement of device information and load information concerning the RAID group of the tier 2 with device information and load information concerning the RAID group of the tier 3. The description of the calculation of the upper IOPS threshold (Xᵤₚ), therefore, is omitted.

The contents of the process by the second calculating unit 604 will be described. As described above using FIG. 8, when a value given by dividing the IOPS (X_{down}) by the number of Sub-LUNs in the RAID group of the tier j is determined to be the lower IOPS threshold (X_{down}) for the tier (j−1), the total IOPS of the RAID group of the tier (j−1) is to be less than an assumed IOPS.

In the same manner as in the case of calculating the upper IOPS threshold (Xᵤₚ), a probability distribution expressed by sorting the IOPSs of Sub-LUNs of the tiered storage in the order of sizes of the IOPSs is assumed to follow the pattern of the Zipf distribution. The second calculating unit 604 calculates the lower IOPS threshold (X_{down}) for the tier (j−1) so that an IOPS representing a load applied to the tier j is the IOPS (X_{down}).

The second calculating unit 604 calculates the number of Sub-LUNs (nⱼ) of the tier j using equation (11). The number of Sub-LUNs (nⱼ) of the tier j may be determined by using a result of calculation by the first calculating unit 603.

The second calculating unit 604 calculates the sum of probabilities (Pj) of Sub-LUNs of the tier j being accessed, using the equations (12) and (13). The sum of probabilities (Pj) may be determined by using a result of calculation by the first calculating unit 603.

The second calculating unit 604 then calculates the IOPS of the a-th Sub-LUN in the case of an IOPS representing a load applied to the tier j being the IOPS (X [symbol] down), as the lower IOPS threshold (X_{down}) for the tier (j−1), using equation (16), where X_{down} denotes the lower IOPS threshold for the tier (j−1), X [symbol] Tdown denotes the average IOPS of read requests in the case of the multiplicity of the RAID group of the j tier being the safe multiplicity (N [symbol] safe), X [symbol] denotes an access probability of a Sub-LUN with the maximum probability of being accessed among Sub-LUNs of the tier j, and Pj denotes the sum of probabilities of Sub-LUNs of the tier j being accessed.

X_{down}=X [symbol] Tdown×x [symbol] a/Pj (16)

An example of calculation of the lower IOPS threshold (X_{down}) for the RAID group of the tier 1 will be described by taking the tier 1 and tier 2 of the tiered storage system 200 as an example. The values of elements necessary for calculating the lower IOPS threshold (X_{down}) are as follows.

Safe multiplicity (N_{safe}): N_{safe=}3

Number of Sub-LUNs (n1): n1≈280
Number of Sub-LUNs (n2): n2≈1230

In this case, the second calculating unit 604 first generates equation (17) expressing the IOPS (X_{Rdown}) in a case of the multiplicity of the RAID group of the tier j being the safe multiplicity (N_{safe}), using equation (4). In equation (17), W_{Rdown} denotes an average response time for response to a read request in the case of the multiplicity of the RAID group of the tier j being the safe multiplicity (N_{safe}). Because Little's law determines a value in units of [sec], the calculated X_{Rdown} is multiplied by 1000 to be expressed in units of [msec].

X_{Rdown}=N_{safe}×1/W_{Rdown}×1000 (17)

The second calculating unit 604 generates equation (18) expressing the average response time (W_{Rdown}) in a case of the average IOPS of read requests to the RAID group of the tier j being the IOPS (X_{Rdown}), using equation (1).

W_{Rdown}=e^{α}^{_{c}}^{X}^{_{Rdown}}+Tₘᵢₙ−1 (18)

The second calculating unit 604 calculates the IOPS (X_{Rdown}) in the case of the multiplicity of the RAID group of the tier j being the safe multiplicity (N_{safe}), using the equations (17) and (18), at which the minimum response time (Tₘᵢₙ) is set to “0.005785” and the exponential factor (α_{c}) is set to “0.00144”. As a result, the IOPS (X_{Rdown}) is calculated as “X_{Rdown}=209.747”.

The second calculating unit 604 then substitutes the IOPS (X_{Rdown}) into equation (5) to calculate the IOPS (X [symbol] Tdown), at which the read request mixed rate (c) is set to “0.75”. As a result, the IOPS (X_{Rdown}) is calculated as “X_{down}=297.667”.

The second calculating unit 604 calculates the sum of probabilities (P2) of Sub-LUNs of the tier 2 being accessed, using equation (13). The sum of probabilities (P2) is calculated as “P2=0.187”, which is indicated by equation (15). The access probability (x₂₈₁) of the 281-th (a=281) Sub-LUN with the maximum probability of being accessed among Sub-LUNs of the tier 2 is calculated as “x₂₈₁=0.0004”.

The second calculating unit 604 then substitutes the values of the IOPS (X [symbol] Tdown), access probability (x₂₈₁), and sum of probabilities (P2) into equation (16) to calculate the lower IOPS threshold (X_{down}) for the tier 1. In this example, the lower IOPS threshold (X_{down}) is calculated as “X_{down}=0.5955”.

Calculating the lower IOPS threshold (X_{down}) for the RAID group of the tier 2 of the tiered storage system 200 merely requires replacement of device information and load information concerning the RAID group of the tier 3 with device information and load information concerning the RAID group of the tier 2. The description of the calculation of the lower IOPS threshold (X_{down}), therefore, is omitted.

The contents of the process by the third calculating unit 606 will be described. The contents of the process by the third calculating unit 606 will be described by taking the RAID group of the tier 2 of the tiered storage system 200 as an example.

It is assumed that the LU size of a LUN used by the user is 1 [TB], that the number of Sub-LUNs in the LUN is “768”, and that in the initial state, all Sub-LUNs in the LUN are allotted from the RAID group of the tier 2. A case is assumed where after an elapse of a given period (e.g., one week), transfer of a Sub-LUN between different tiers has been performed according to the upper IOPS threshold (Xᵤₚ) and the lower IOPS threshold (X_{down}) set for the second tier.

Load information indicating load applied to the RAID group of each tier after an elapse of the given period is as follows, where IOPS (x) is the average IOPS of I/O requests to the tiered storage system 200.

IOPS (x): x=70

I/O size (r [symbol] ):=48 [KB]
I/O size (r [symbol] ):=48 [KB]
Read request mixed rate (c): c=0.75

It is also assumed that a distribution of IOPSs for individual Sub-LUNs follows the pattern of the Zipf distribution. For this reason, a probability (xᵢ) of a Sub-LUN with the i-th largest IOPS being accessed can be expressed using, for example, equation (12).

The third calculating unit 606 first calculates the IOPS (Xᵢ) of the Sub-LUN with the i-th largest IOPS, using equation (19), where i=1, 2, . . . , 768.

$${x}_{i} = 70 {x}_{i} = 70 \frac{\frac{1}{i}}{{\sum }_{i = 1}^{768} \frac{1}{i}} \qquad ( 19 )$$

The third calculating unit 606 calculates the number of Sub-LUNs (K) with IOPSs for individual Sub-LUNs less than or equal to the upper IOPS threshold (Xᵤₚ) for the tier 2 and greater than the lower IOPS threshold (X_{down}) for the tier 2, based on the calculated IOPS (X.). The number of Sub-LUNs (K) is the number of Sub-LUNs allotted from the RAID group of the tier 2 to the LUN, that is, the number of Sub-LUNs belonging to the tier 2.

The upper IOPS threshold (Xᵤₚ) for the tier 2 is set to “0.633”, and the lower IOPS threshold (X_{down}) for the tier 2 is set to “0.098”. In this case, the number of Sub-LUNs (K) is calculated as “K=83”.

The third calculating unit 606 calculates the capacity ratio (CR2) of the RAID group of the tier 2, based on the calculated number of Sub-LUNs (K). For example, the third calculating unit 606 can calculate the capacity ratio (CR2) of the RAID group of the tier 2 using equation (20), where Pj denotes the capacity ratio of the RAID group of the tier j, K denotes the number of Sub-LUNs belonging to the tier j, d denotes the Sub-LUN size of each Sub-LUN, and LN denotes the LU size of the LUN.

Pj=K×d/LU (20)

The Sub-LUN size (d) is set to “1.3 [GB]”, and the LU size (LU) of the LUN is set to “1 [TB]=1024 [GB]”. In this case, the capacity ratio (CR2) of the RAID group of the tier 2 is calculated as “CR2≈0.1063”.

The third calculating unit 606 calculates the sum total (X [symbol] sum) of the IOPSs of Sub-LUNs belonging to the tier 2, based on the calculated IOPS (X₁), at which the number of Sub-LUNs belonging to the tier 1 is set to “15”.

In this case, the third calculating unit 606 calculates the sum total (X [symbol] sum) of the IOPSs of Sub-LUNs belonging to the tier 2 by adding up the IOPS (X₁₆) to IOPS (X [symbol] ) of the 16-th Sub-LUN to 98-th Sub-LUN. The sum total (X [symbol] ) of the IOPSs of Sub-LUNs belonging to the tier 2 is thus calculated as “X [symbol] =17.88”.

The third calculating unit 606 then substitutes the calculated sum total (X [symbol] num) of the IOPSs of Sub-LUNs belonging to the tier 2 into a response model to calculate an average response time (W [symbol] ) of the RAID group of the tier 2 for response to a read request. The response model is, for example, equation (1).

The exponential factor (α_{c}) and the minimum response time (Tₘᵢₙ) included in equation (1) are set to “0.00782” and “4.223 [msec]”, respectively. In this case, the average response time (W_{R}) is calculated as “W_{R}=4.33 [msec]”.

The third calculating unit 606 then substitutes the calculated average response time (W [symbol] ) into equation (21) to calculate an average response time (W) of the RAID group of the tier 2 for response to an I/O request. In equation (21), c denotes a read request mixed rate.

W=c×W_{R} (21)

The read request mixed rate (c) is set to “0.75”. As a result, the average response time (W) of the RAID group of the tier 2 for response to a read request is calculated as “W=3.25 [msec]”.

An example of generating a response model used by the third calculating unit 606 is the same as the example explained above and is, therefore, omitted in further description.

The use rate v of the RAID group is give as “v=1” in the above description. In this example, however, the generating unit 602 calculates the use rate v using equation (22), where d denotes the Sub-LUN size of each Sub-LUN, K denotes the number of Sub-LUNs belonging to the tier j, R denotes the RAID rank of the RAID group of the tier j, and D denotes the disk size of the RAID group of the tier j.

v=(d×K)/(0.9×R×D) (22)

Equation (22) is derived by utilizing a fact that the actual capacity of the RAID group is 90[%] of the product of the disk size (D) and the RAID rank (R).

An example of a load threshold calculation screen displayed on the display 309 of the load threshold calculating apparatus 100 will be described. An example of a load threshold calculation screen will be described for a case of calculating a load threshold for each tier of the tiered storage system 200 of FIG. 2.

FIGS. 9, 10, and 11 are explanatory diagrams of examples of load threshold calculation screens. In FIG. 9, a load threshold calculation screen 900 is a screen displayed on the display 309 when a load threshold for each tier of the tiered storage system is calculated.

On the load threshold calculation screen 900, the user moves a cursor CS and clicks boxes 901 to 904 through an input operation on the keyboard 310 or the mouse 311, thereby enters load information representing a load applied to the tiered storage.

For example, the average IOPS of I/O requests to the tiered storage system 200 can be entered in the box 901. The average I/O size of read requests to the RAID group of each tier of the tiered storage system 200 can be entered in the box 902. The average I/O size of write requests to the RAID group of each tier can be entered in the box 903. A read request mixed rate at each tier can be entered in the box 904.

In the boxes 901 to 904, for example, typical load information in a case of using the tiered storage system 200 as a file server is entered in advance. If a load applied to the tiered storage is unknown, this pre-entered load information can be used. In this example, pre-entered load information is used as load information indicating a load applied to the tiered storage.

On the load threshold calculation screen 900, the LU size of a LUN used by the user can be entered by moving the cursor CS and clicking a box 905. On the load threshold calculation screen 900, the RAID rank of the RAID group of each tier of the tiered storage system 200 can be entered by moving the cursor CS and clicking a box 906. On the load threshold calculation screen 900, the disk size of the RAID group of each tier of the tiered storage system 200 can be entered by moving the cursor CS and clicking a box 907.

On the load threshold calculation screen 900 of FIG. 10, the LU size “1 [TB]” of the LUN used by the user is entered in the box 905. On the load threshold calculation screen 900, the RAID ranks “2, 3, 5” of the RAID groups of the tier 1 to tier 3 of the tiered storage system 200 are entered in the box 906. On the load threshold calculation screen 900, the disk sizes “200 [GB], 600 [GB], 1 [TB]” of the RAID groups the tier 1 to tier 3 of the tiered storage system 200 are entered in a box 907.

On the load threshold calculation screen 900, following input of various information, the cursor CS is moved to click a calculation button B. Clicking on the calculating button B enters an instruction to start a calculation process of calculating a load threshold for each tier of the tiered storage system 200. The load threshold calculating apparatus 100 thus calculates the load threshold, the capacity ratio, and the average response time for response to an I/O request of each tier of the tiered storage system 200.

On the load threshold calculation screen 900 of FIG. 11, load thresholds for the tiers of the tiered storage system 200 are indicated in boxes 908 to 911. For example, an upper IOPS threshold “0.633” that distinguishes the tier 1 from the tier 2 of the tiered storage system 200 is indicated in the box 908. An upper IOPS threshold “0.098” that distinguishes the tier 2 from the tier 3 of the tiered storage system 200 is indicated in the box 909. A lower IOPS threshold “0.595” that distinguishes the tier 1 from the tier 2 of the tiered storage system 200 is indicated in the box 910. A lower IOPS threshold “0.098” that distinguishes the tier 2 from the tier 3 of the tiered storage system 200 is indicated in the box 911.

On the load threshold calculation screen 900, capacity ratios and average response times of the tiers of the tiered storage system 200 are indicated in boxes 912 to 917 for each of average IOPSs “50, 70, 90” representing loads applied to the tiered storage system 200.

For example, capacity ratios of the tier 1, tier 2, and tier 3 of the tiered storage system 200 are indicated as “1.28[%], 7.68[%], and 91.04[%]” in the box 912. Average response times of respective tiers of the tiered storage system 200 for response to an I/O request are indicated as “1.5 [ms], 3.20 [ms], and 8.22 [ms]” in the box 913. An average response time (total average response time) of the tiered storage system 200 for response to an I/O request is indicated as “4.18 [ms]” in the box 913.

The capacity ratios of the tier 1, tier 2, and tier 3 of the tiered storage system 200 in a case of the average IOPS being 70 are indicated as “1.92[%], 10.63[%], and 87.45[%]” in the box 914. Average response times of respective tiers of the tiered storage system 200 for response to an I/O request are indicated as “1.5 [ms], 3.25 [ms], and 8.23 [ms]” in the box 915. An average response time (total average response time) of the tiered storage system 200 for response to an I/O request is indicated as “3.87 [ms]” in the box 915.

The capacity ratios of the tier 1, tier 2, and tier 3 of the tiered storage system 200 in a case of the average IOPS being 90 are indicated as “2.43[%], 13.70[%], and 83.87[%]” in the box 916. Average response times of respective tiers of the tiered storage system 200 for response to an I/O request are indicated as “1.5 [ms], 3.30 [ms], and 8.22 [ms]” in the box 917. An average response time (total average response time) of the tiered storage system 200 for response to an I/O request is indicated as “3.66 [ms]” in the box 917.

The average response times of the SSD of the tier 1 are determined evenly to be “1.5 [ms]” for the reason that I/O request processing loads to the SSD are extremely small compared to the processing capability of the SSD. The average response time of the tiered storage system 200 for response to an I/O request is calculated by the load threshold calculating apparatus 100, which calculates the average response time by dividing the sum of the products of IOPSs and average response times of the tiers by the sum of IOPSs of the tiers.

On the load threshold calculating screen 900, the user can determine an IOPS threshold representing a load threshold set for each tier of the tiered storage system 200. The user can also determine the capacity ratio and the average response of each tier in a case of transferring a Sub-RUN according to the IOPS threshold for each tier, for each average IOPS representing a load applied to the tiered storage system 200.

When every Sub-LUN in a LUN is allotted from the SAS of the tier 2, the average response time for response to an I/O request is calculated (calculation details are not described) at 4.53 [ms]. In comparison with this, for example, the average response time (total average response time) for response to an I/O request for the case of the average IOPS being “70” is indicated as 3.87 [ms]. This demonstrates that transferring a Sub-LUN according to an IOPS threshold for each tier improves response performance, compared to the case of allotting every Sub-LUN from the SAS.

In the example of FIG. 11, the SSD costing more than the SAS is used. However, the capacity ratio of the SSD is extremely small while the same of the NL-SAS is large. As a result, the overall cost turns out to be less than the overall cost in the case of allotting every Sub-LUN from the SAS. In this manner, transferring a Sub-LUN according to the IOPS threshold for each tier improves the response performance as well as operation cost of the tiered storage system 200.

A load threshold calculating procedure by the load threshold calculating apparatus 100 will be described. The procedure will be described by taking the tiered storage system 200 of FIG. 2 as an example.

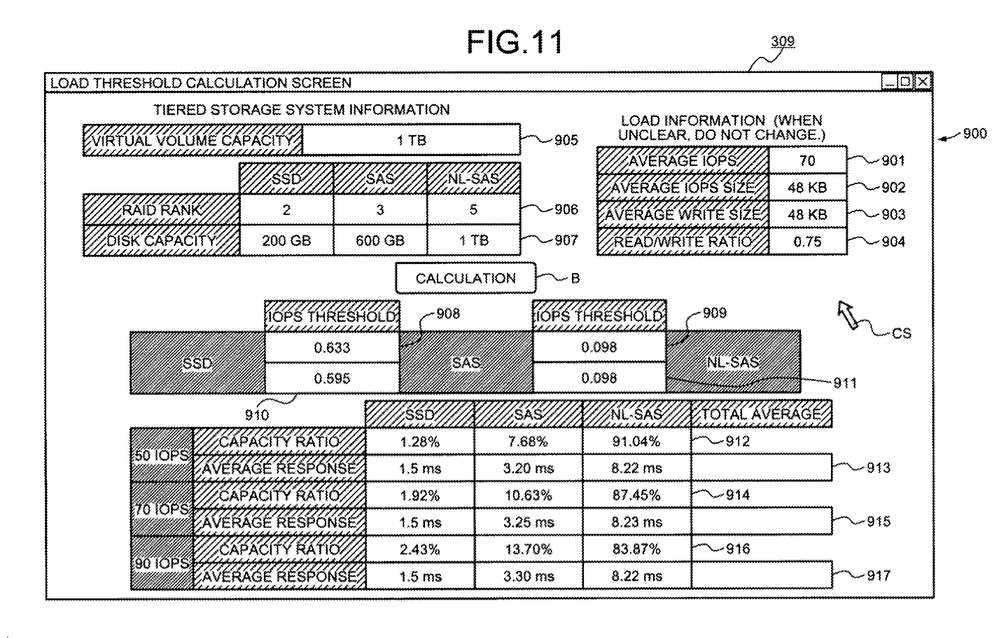

FIG. 12 is a flowchart of one example of the load threshold calculating procedure by the load threshold calculating apparatus 100. In the flowchart of FIG. 12, the load threshold calculating apparatus 100 first determines whether device information and load information concerning the tiered storage system 200 has been acquired (step S1201).

The load threshold calculating apparatus 100 stands by until the device information and load information have been acquired (step S1201: NO). When having acquired the device information and load information (step S1201: YES), the load threshold calculating apparatus 100 executes a response model generating process based on the acquired device information and load information (step S1202).

Based on the acquired device information, the load threshold calculating apparatus 100 calculates the number of Sub-LUNs (n1) to (n3) of the tier 1 to tier 3 of the tiered storage system 200, using equation (11) (step S1203). Based on the acquired device information and load information, the load threshold calculating apparatus 100 executes a tier 1/tier 2 upper IOPS threshold calculating process (step S1204).

Based on the acquired device information and load information, the load threshold calculating apparatus 100 executes a tier 1/tier 2 lower IOPS threshold calculating process (step S1205). Subsequently, the load threshold calculating apparatus 100 determines whether a lower IOPS threshold for the tier 1 (X_{down} [1]) is greater than an upper IOPS threshold for the tier 2 (Xᵤₚ [2]) (step S1206).

If the lower IOPS threshold for the tier 1 (X_{down} [1]) is less than or equal to the upper IOPS threshold for the tier 2 (Xᵤₚ [2]) (step S1206: NO), the load threshold calculating apparatus 100 proceeds to step S1208.

If the lower IOPS threshold for the tier 1 (X_{down} [1]) is greater than the upper IOPS threshold for the tier 2 (Xᵤₚ [2]) (step S1206: YES), the threshold calculating apparatus 100 determines the lower IOPS threshold for the tier 1 (X_{down} [1]) to be the upper IOPS threshold for the tier 2 (Xᵤₚ [2]) (step S1207).

Subsequently, based on the acquired device information and load information, the load threshold calculating apparatus 100 executes a tier 2/tier 3 upper IOPS threshold calculating process (step S1208). Based on the acquired device information and load information, the threshold calculating apparatus 100 executes a tier 2/tier 3 lower IOPS threshold calculating process (step S1209).

Subsequently, the load threshold calculating apparatus 100 determines whether a lower IOPS threshold for the tier 2 (X_{down} [2]) is greater than an upper IOPS threshold for the tier 3 (Xᵤₚ [3]) (step S1210). If the lower IOPS threshold for the tier 2 (X_{down} [2]) is less than or equal to the upper IOPS threshold for the tier 3 (Xᵤₚ [3]) (step S1210: NO), the load threshold calculating apparatus 100 proceeds to step S1212.

If the lower IOPS threshold for the tier 2 (X_{down} [2]) is greater than the upper IOPS threshold for the tier 3 (Xᵤₚ [3]) (step S1210: YES), the threshold calculating apparatus 100 determines the lower IOPS threshold for the tier 2 (X_{down} [2]) to be the upper IOPS threshold for the tier 3 (Xᵤₚ [3]) (step S1211).

The load threshold calculating apparatus 100 thus sets the upper IOPS thresholds for the tier 2 and tier 3 to the upper IOPS thresholds (Xᵤₚ [2]) and (Xᵤₚ [3]), respectively (step S1212). The threshold calculating apparatus 100 sets the lower IOPS thresholds for the tier 1 and tier 2 to the lower IOPS thresholds (X_{down} [1]) and (X_{down} [2]), respectively (step S1213).

Finally, the threshold calculating apparatus 100 outputs a setting result (step S1214) and ends the series of steps in the flowchart.

In this manner, the upper IOPS threshold (Xᵤₚ) and/or lower IOPS threshold (X_{down}) for I/O requests to a Sub-LUN can be set, as a load threshold for a load applied to a Sub-LUN of each tier of the tiered storage system 200.

A procedure of the response model generating process at step S1202 of FIG. 12 will be described. A case of generating a response model expressing an average response time of the RAID group of the tier j for response to a read request will be described.

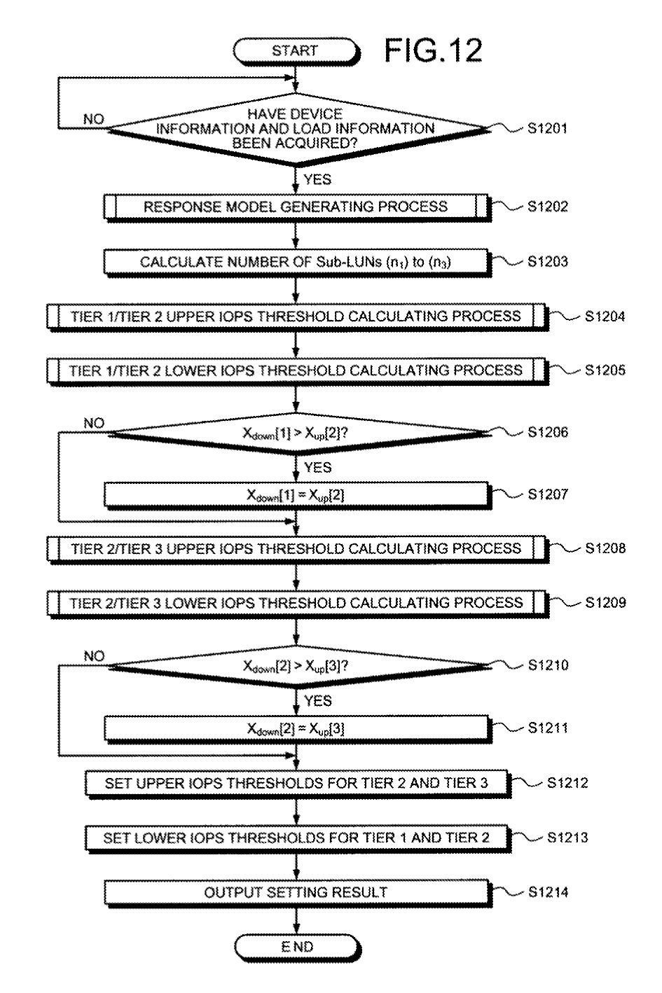

FIG. 13 is a flowchart of an example of a procedure of the response model generating process. In the flowchart of FIG. 13, based on device information and load information, the load threshold calculating apparatus 100 first calculates the maximum IOPS (X_{N}) of the RAID group in a case of the multiplicity (N), using equation (6) (step S1301).

Based on the multiplicity (N) and the maximum IOPS (X_{N}) of the RAID group in the case of the multiplicity (N), the load threshold calculating apparatus 100 calculates the response time (W_{N}) of the RAID group for response to a read request, using equation (4) (step S1302). Based on the device information and load information, the load threshold calculating apparatus 100 calculates the minimum response time (Tₘᵢₙ) for response to a read request, using equation (7) (step S1303).

The load threshold calculating apparatus 100 substitutes the calculated the maximum IOPS (X_{N}), response time (W_{N}), and minimum response time (Tₘᵢₙ) into equation (8) to calculate an exponential factor (α₁) (step S1304).

Based on the acquired load information, the load threshold calculating apparatus 100 calculates the read request mixed rate (c), using equation (3) (step S1305). Based on the acquired load information, the load threshold calculating apparatus 100 calculates the I/O size ratio (t), using equation (10) (step S1306).

The load threshold calculating apparatus 100 substitutes the exponential factor (α₁), the read request mixed rate (c), and the I/O size ratio (t) into equation (9) to calculate the exponential factor (α_{c}) in a case of the read request mixed rate (c) (step S1307).

The load threshold calculating apparatus 100 substitutes the exponential factor (α_{c}) and the minimum response time (Tₘᵢₙ) into equation (1) to generate a response model expressing the average response time (W) for response to a read request (step S1308), and ends the series of steps in the flowchart.

In this manner, the response model expressing the average response time (W) for response to a read request, which average response time (W) increases exponentially with an increase in the IOPS (X) of read requests, can be made.

A procedure of the tier 1/tier 2 upper IOPS threshold calculating process at step S1204 of FIG. 12 will be described.

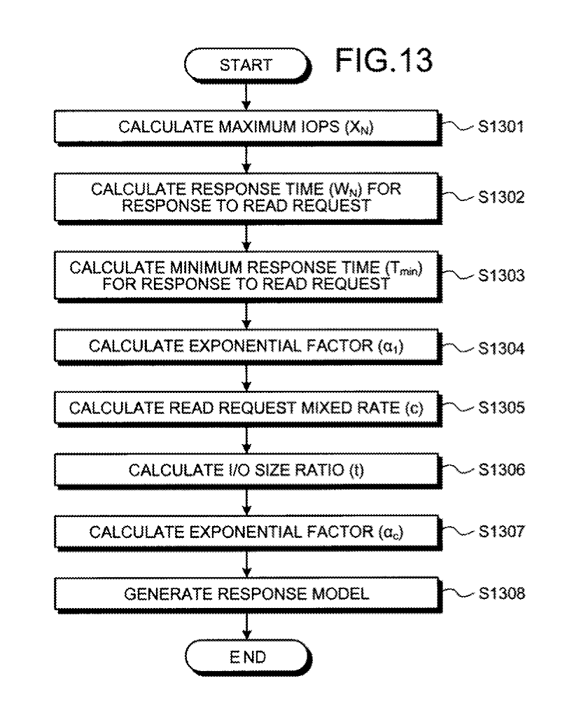

FIG. 14 is a flowchart of an example of the procedure of the tier 1/tier 2 upper IOPS threshold calculating process. In the flowchart of FIG. 14, based on device information, the load threshold calculating apparatus 100 substitutes the maximum response time (Wₘₐₓ) of the RAID group of the second tier into a generated response model to calculate the IOPS (Xₘₐₓ) in a case of the maximum response time (Wₘₐₓ) (step S1401).

Based on load information and the IOPS (X_{Rup}), the load threshold calculating apparatus 100 calculates the IOPS (X_{Tup}), using the equations (2) and (3) (step S1402). The load threshold calculating apparatus 100 calculates the access probability (x₂₈₁) of the 281-th (a=281) Sub-LUN with the maximum probability of being accessed among Sub-LUNs of the tier 2, using equation (12) (step S1403).

The load threshold calculating apparatus 100 calculates the sum of probabilities (P2) of Sub-LUNs of the tier 2 being accessed, using the equations (12) and (13) (step S1404). Finally, the load threshold calculating apparatus 100 calculates an upper IOPS threshold (Xᵤₚ [2]) for the tier 2, using equation (14) (step S1405), and ends the series of steps in the flowchart.

In this manner, the IOPS of the 281-th Sub-LUN in a case of an IOPS representing a load applied to the tier 2 being the IOPS (X_{Tup}) can be calculated, as the upper IOPS threshold for the tier 2.

The procedure of the tier 2/tier 3 upper IOPS threshold calculating process at step S1208 of FIG. 12 is the same as the procedure of the tier 1/tier 2 upper IOPS threshold calculating process of FIG. 14 and is, therefore, omitted in further description.

A procedure of the tier 1/tier 2 lower IOPS threshold calculating process at step S1205 of FIG. 12 will be described.

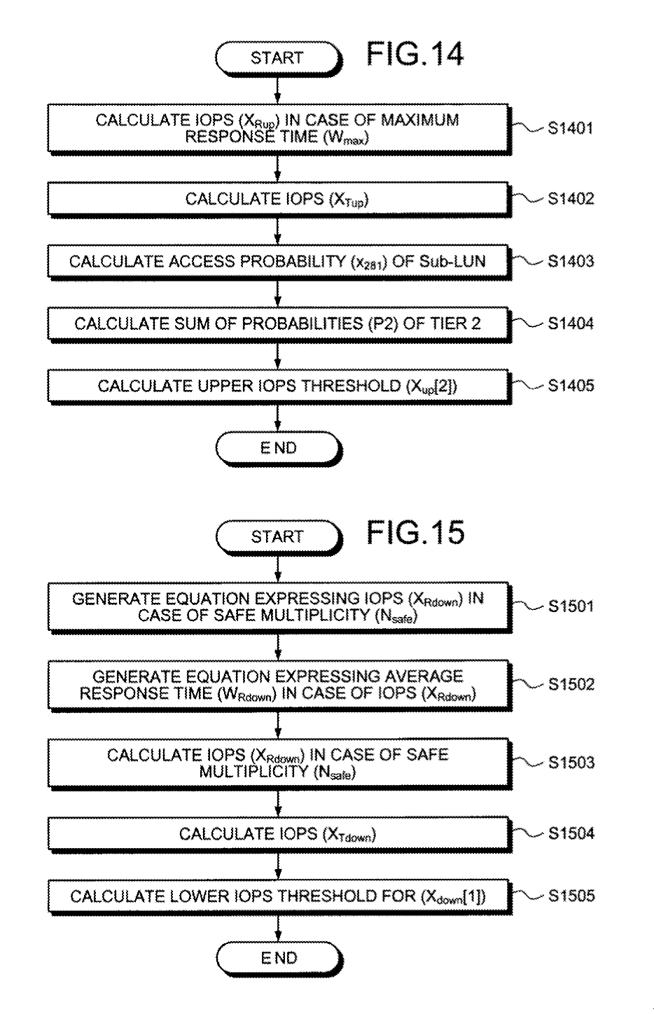

FIG. 15 is a flowchart of an example of the procedure of the tier 1/tier 2 lower IOPS threshold calculating process. In the flowchart of FIG. 15, based on device information, the load threshold calculating apparatus 100 first generates an equation expressing the IOPS (X_{Rdown}) in a case of the multiplicity of the RAID group of the tier 2 being the safe multiplicity (N_{safe}), using equation (14) (step S1501). The equation expressing the IOPS (X_{Rdown}) is, for example, equation (17).

The load threshold calculating apparatus 100 generates an equation expressing the average response time (W_{Rdown}) in a case of the average IOPS of read requests to the RAID group of the tier 2 being the IOPS (X_{Rdown}), using a generated response model (step S1502). The equation expressing the average response time (W_{Rdown}) is, for example, equation (18).

The load threshold calculating apparatus 100 calculates the IOPS (X_{Rdown}) in the case of the multiplicity of the RAID group of the tier 2 being the safe multiplicity (N_{safe}), using the generated equation expressing the IOPS (X_{Rdown}) and equation expressing average response time (W_{Rdown}) (step S1503).

The load threshold calculating apparatus 100 substitutes the IOPS (X_{Rdown}) into equation (5) to calculate the IOPS (X [symbol] down) (step S1504). Finally, the load threshold calculating apparatus 100 calculates a lower IOPS threshold for the tier 1 (X_{down[1]}) (step S1505), and ends the series of steps in the flowchart.

At step S1505, the access probability (x₂₈₁) of the 281-th (a=281) Sub-LUN with the maximum probability of being accessed among Sub-LUNs of the tier 2 can be determined by using the result of calculation at step S1403 of FIG. 14. Similarly, the sum of probabilities (P2) of Sub-LUNs of the tier 2 being accessed can be determined by using the result of calculation at step S1404 of FIG. 14.

In this manner, the IOPS of the 281-th Sub-LUN in a case of an IOPS representing a load applied to the tier 2 being the IOPS (X_{down}) can be calculated, as the lower IOPS threshold for the tier 1.

The procedure of the tier 2/tier 3 lower IOPS threshold calculating process at step S1209 of FIG. 12 is the same as the procedure of the tier 1/tier 2 lower IOPS threshold calculating process of FIG. 15, and is therefore omitted in further description.

A procedure of a screen generating process by the load threshold calculating apparatus 100 will be described. The screen generating process is, for example, the process of generating the load threshold calculation screen 900 of FIGS. 9 to 11.

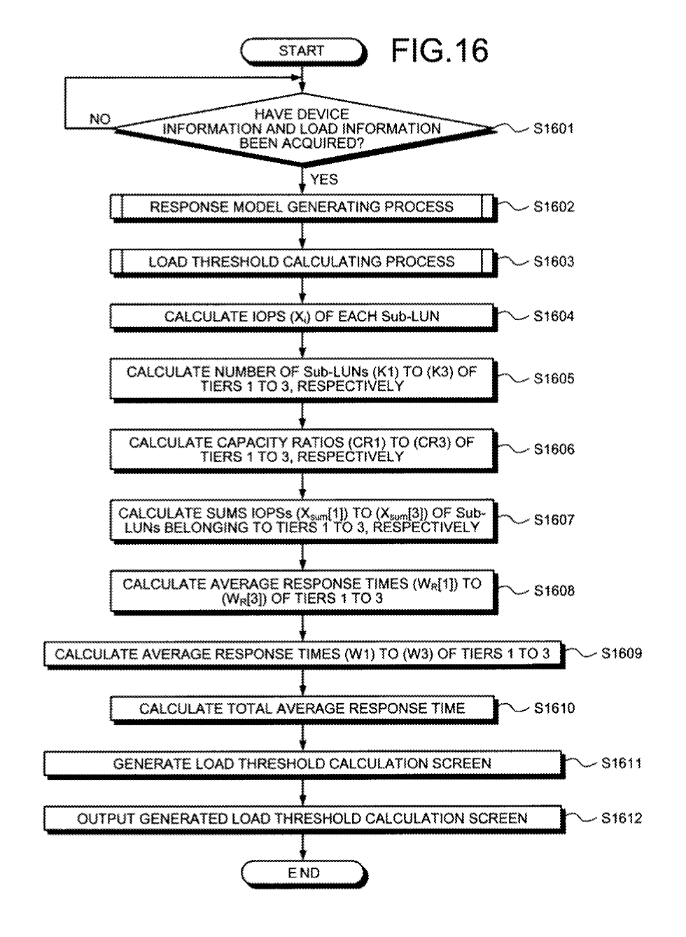

FIG. 16 is a flowchart of an example of the procedure of the screen generating process by the load threshold calculating apparatus 100. In the flowchart of FIG. 16, the load threshold calculating apparatus 100 first determines whether device information and load information concerning the tiered storage system 200 have been acquired (step S1601).

The load threshold calculating apparatus 100 stands by until the device information and load information have been acquired (step S1601: NO). When having acquired the device information and load information (step S1601: YES), the load threshold calculating apparatus 100 executes the response model generating process based on the acquired device information and load information (step S1602).

Subsequently, based on the acquired device information and load information, the load threshold calculating apparatus 100 executes the load threshold calculating process (step S1603). Based on the acquired device information and load information, the load threshold calculating apparatus 100 calculates the IOPS (Xᵢ) of each Sub-LUN, using equation (19) (step S1604).

Based on the calculated IOPS (Xᵢ) of each Sub-LUN and load threshold for each tier, the load threshold calculating apparatus 100 calculates the number of Sub-LUNs (K1) to (K3) of the tier 1 to tier 3, respectively (step S1605). Based on the acquired device information and load information, the load threshold calculating apparatus 100 calculates capacity ratios (CR1) to (CR3) of the RAID groups of the tier 1 to Tier 3, respectively, using equation (20) (step S1605).

Based on the calculated IOPS (Xᵢ) of each Sub-LUN, the load threshold calculating apparatus 100 calculates the sums of the IOPSs (X [symbol] [1]) to (X [symbol] [3]) of Sub-LUNs belonging to the tier 1 to tier 3, respectively (step S1607).

The load threshold calculating apparatus 100 substitutes the sums of the IOPSs (X [symbol] [1]) to (X [symbol] [3]) into a response model to calculate average response times (W_{R} [1]) to (W [symbol] [3]) of the RAID groups of the tier 1 to tier 3 for response to read requests (step S1608).

The threshold calculating apparatus 100 substitutes the average response times (W_{R} [1]) to (W_{R} [3]) into equation (21) to calculate average response times (W1) to (W3) of the RAID groups of the tier 1 to tier 3 for response to I/O requests (step S1609).

The load threshold calculating apparatus 100 calculates a total average response time of the RAID groups of the tier 1 to tier 3 for response to I/O requests (step S1610). Based on various calculation results, the load threshold calculating apparatus 100 generates the load threshold calculation screen (step S1611). The load threshold calculating apparatus 100 outputs the generated load threshold calculation screen (step S1612), and ends the series of steps in the flowchart.

In this manner, the load threshold calculation screen can be generated, which screen displays an average response time representing the capacity ratio and response performance of each tier in a case of transferring a Sub-LUN according to a load threshold set for each tier of the tiered storage system 200.

The procedure of the response model generating process at step S1602 is the same as the procedure of the response model generating process of FIG. 13, and is therefore omitted in further description. The procedure of the load threshold calculating process at step S1603 is the same as the procedure of the load threshold calculating process of FIG. 12, and is therefore omitted in further description.

An operation procedure will be described, according to which procedure the load threshold calculating apparatus 100 is applied to the tiered storage system 200 to automate transfer of a Sub-LUN between different tiers based on a threshold for each tier. This operation procedure is executed, for example, at every pre-set given period. The given period is, for example, one week or one month.

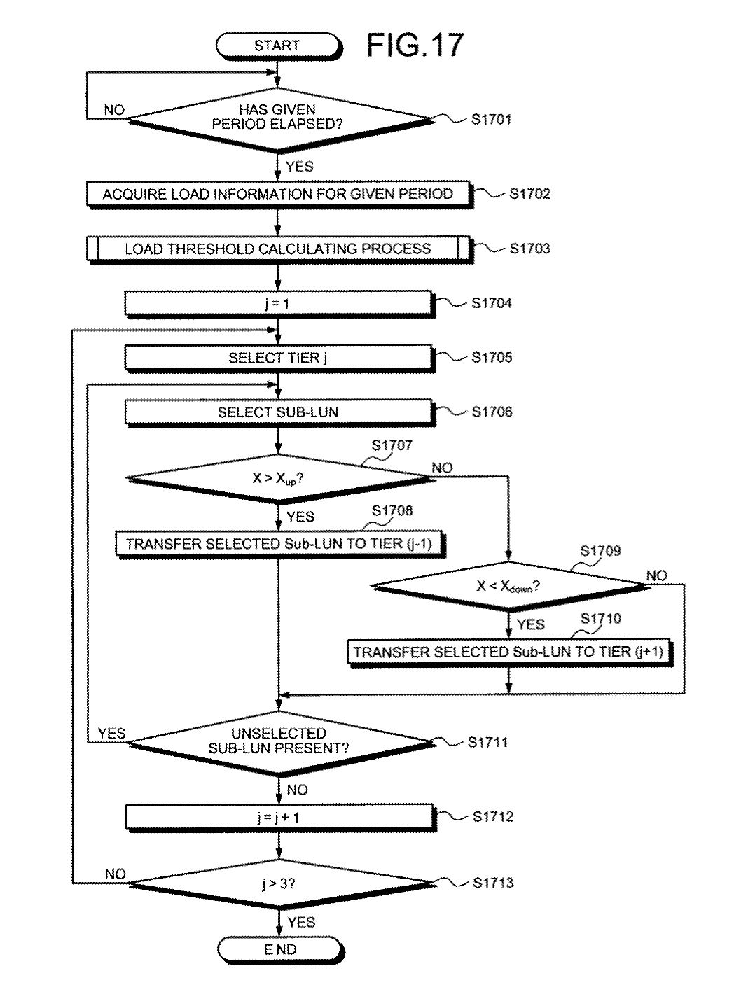

FIG. 17 is a flowchart of an example of the operation procedure by the load threshold calculating apparatus 100. In the flowchart of FIG. 17, the load threshold calculating apparatus 100 first determines whether the given period has elapsed (step S1701).

The load threshold calculating apparatus 100 stands by until the given period passes (step S1701: NO). When the given period has passed (step S1701: YES), the load threshold calculating apparatus 100 acquires load information of the tiered storage system 200 for the given period (step S1702).

This load information includes information included in the load information 500 of FIG. 5 and the average IOPS of each Sub-LUN in the tiered storage system 200 (hereinafter “IOPS (X)”). The load information, for example, is acquired through real-time measurement by the load threshold calculating apparatus 100 and is stored in such memory devices as RAM 303, magnetic disk 305, and optical disk 307.

Based on the acquired load information and device information concerning the tiered storage system 200, the load threshold calculating apparatus 100 executes the load threshold calculating process (step S1703). The device information concerning the tiered storage system 200 is stored, for example, in such memory devices as RAM 303, magnetic disk 305, and optical disk 307.

The load threshold calculating apparatus 100 sets “j” of the tier j to 1 (step S1704) and selects the tier j of the tiered storage system 200 (step S1705). The threshold calculating apparatus 100 selects a Sub-LUN belonging to the selected tier j (step S1706).

Based on the acquired load information, the load threshold calculating apparatus 100 determines whether the IOPS (X) of the selected Sub-LUN is greater than the upper IOPS threshold (Xᵤₚ) set for the tier j (step S1707).

If the IOPS (X) is greater than the upper IOPS threshold (Xᵤₚ) (step S1707: YES), the load threshold calculating apparatus 100 transfers the selected Sub-LUN to the tier (j−1) (step S1708).

If the IOPS (X) is less than or equal to the upper IOPS threshold (Xᵤₚ) (step S1707: NO), the load threshold calculating apparatus 100 determines whether the IOPS (X) of the selected Sub-LUN is less than the lower IOPS threshold (X_{down}) set for the tier j (step S1709).

If the IOPS (X) is less than the lower IOPS threshold (X_{down}) (step S1709: YES), the load threshold calculating apparatus 100 transfers the selected Sub-LUN to the tier (j+1) (step S1710). If the IOPS (X) is greater than or equal to the lower IOPS threshold (X_{down}) (step S1709: NO), the load threshold calculating apparatus 100 proceeds to step S1711.

The load threshold calculating apparatus 100 determines whether an unselected Sub-LUN is present among Sub-LUNs belonging to the selected tier j (step S1711). If an unselected Sub-LUN is present (step S1711: YES), the load threshold calculating apparatus 100 returns to step S1706 and selects the unselected Sub-LUN.

If an unselected Sub-LUN is not present (step S1711: NO), load threshold calculating apparatus 100 increases “j” of the tier j by 1 (step S1712) and determines whether “j” of the tier j is greater than “3” (step S1713).

If “j” of the tier j is less than or equal to “3” (step S1713: NO), the threshold calculating apparatus 100 returns to step S1705. If “j” of the tier j is greater than “3” (step S1713: YES), the load threshold calculating apparatus 100 ends the series of steps in the flowchart.

If the upper IOPS threshold (Xᵤₚ) is not set for the tier j at step S1707, the load threshold calculating apparatus 100 proceeds to step S1709. If the lower IOPS threshold (X_{down}) is not set for the tier j at step S1709, the load threshold calculating apparatus 100 proceeds to step S1711.

Through this procedure, transfer of a Sub-LUN between different tiers based on a threshold set for each tier is automated. The procedure of the load threshold calculating process at step S1703 is the same as the procedure of the load threshold calculating process of FIG. 12, and is therefore omitted in further description.

As described above, according the load threshold calculating apparatus 100 of the embodiment, the upper IOPS threshold (Xᵤₚ) for I/O requests to a Sub-LUN of the tier j can be calculated based on the IOPS (X_{Rup}) in the case the maximum response time (Wₘₐₓ). As a result, the upper IOPS threshold (Xᵤₚ) for I/O requests to each Sub-LUN can be set as a load threshold for a load applied to a Sub-LUN of each tier of the tiered storage. For example, a load threshold can be set as a load threshold allowing a determination that if the average IOPS of each Sub-LUN of the tier j is less than the upper IOPS threshold (Xᵤₚ), the RAID group of the tier j has response performance sufficient as required response performance.

According to the load threshold calculating apparatus 100, the upper IOPS threshold (Xᵤₚ) can be calculated based on the IOPS (X_{Tup}) acquired from the IOPS (X_{Rup}) and the read request mixed rate (c). As a result, the upper IOPS threshold (Xᵤₚ) for the case of read request and write requests being mixed together can be calculated.

According to the load threshold calculating apparatus 100, the upper IOPS threshold (Xᵤₚ) can be calculated based on the IOPS (X_{Tup}), the sum of probabilities (Pj) of Sub-LUNs of the tier j being accessed, and the access probability (x [symbol] ) of a Sub-LUN with the maximum probability of being accessed among Sub-LUNs of the tier j.

For example, according to the load threshold calculating apparatus 100, the IOPS of the Sub-LUN with the maximum probability of being accessed among Sub-LUNs of the tier j can be calculated as the upper IOPS threshold (Xᵤₚ) for the case of an IOPS representing a load applied to the tier j being the IOPs (X [symbol] up). As a result, the upper IOPS threshold (Xᵤₚ) can be calculated for the case of a probability distribution expressed by sorting the IOPSs of Sub-LUNs of the tiered storage in the order of size of the IOPSs following the pattern of the Zipf distribution.

According to the load threshold calculating apparatus 100, the lower IOPS threshold (X_{down}) for the tier (j−1) can be calculated based on the IOPS (X_{Rdown}) in the case of the multiplicity of the RAID group of the tier j being the safety multiplicity (N_{safe}). As a result, the lower IOPS threshold (X_{down}) for I/O requests to each Sub-LUN can be set as a load threshold for a load applied to a Sub-LUN of each tier of the tiered storage. For example, a load threshold can be set as a load threshold for identifying a Sub-LUN that is expected to process I/O requests at optimum process performance when transferred from the tier (j−1) to the tier j.

According to the load threshold calculating apparatus 100, the lower IOPS threshold (X_{down}) for the tier (j−1) can be calculated based on the IOPS (X_{Tdown}) acquired from the IOPS (X_{Rdown}) of the tier 1 and the read request mixed rate (c). As a result, the lower IOPS threshold (X_{down}) for the case of read request and write requests being mixed together can be calculated.

According to the load threshold calculating apparatus 100, the lower IOPS threshold (X_{down}) for the tier (j−1) can be calculated based on the IOPS (X_{Tdown}) of the tier 1, the sum of probabilities (Pj) of Sub-LUNs of the tier j being accessed, and the access probability (x [symbol] ) of the Sub-LUN with the maximum probability of being accessed among Sub-LUNs of the tier j.

For example, according to the load threshold calculating apparatus 100, the IOPS of the Sub-LUN with the maximum probability of being accessed among Sub-LUNs of the tier j can be calculated as the lower IOPS threshold (X_{down}) for the tier (j−1) for the case of an IOPS representing a load applied to the tier j being the IOPs (X_{Tdown}). As a result, the upper IOPS threshold (X_{down}) for the tier (j−1) can be calculated for the case of a probability distribution expressed by sorting the IOPSs of Sub-LUNs of the tiered storage in the order of size of the IOPSs following the pattern of the Zipf distribution.

According to the load threshold calculating apparatus 100, the capacity ratio (CRj) of the tier j can be calculated for a case of transferring a Sub-LUN according to the upper IOPS threshold (X [symbol] ) and/or lower IOPS threshold (X_{down}) for each tier. As a result, the user can determine at what ratio Sub-LUNs making up a LUN are allotted to each tier of the tiered storage.

According to the load threshold calculating apparatus 100, the average response time (W) of the RAID group of the tier j for response to I/O requests can be calculated for the case of transferring a Sub-LUN according to the upper IOPS threshold (Xᵤₚ) and/or lower IOPS threshold (X_{down}) for each tier. This allows the user to assess the response performance of the RAID group of the tier j in response to I/O requests for the case of transferring a Sub-LUN according to the upper IOPS threshold (Xᵤₚ) and/or lower IOPS threshold (X_{down}) for each tier.

Hence, the load threshold calculating apparatus 100 makes it easier for the user to determine data that should preferably be transferred from one tier to another tier of the tiered storage, thereby assists the user in efficiently assigning data to each tier of the tiered storage.

The load threshold calculating method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to one aspect of the present invention, efficient support in the assignment of data to multiple storage devices is effected.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program causing a computer to execute a load threshold calculating process, the load threshold calculating process comprising:
acquiring for a second storage device, a required maximum response time for response to a read request, the second storage device having a lower response performance to an access request that represents a read request or write request than a first storage device;
substituting the acquired maximum response time into a response model expressing for the second storage device, a response time for response to the read request, the response time increasing exponentially with an increase in the number of read requests and according to an exponent denoting the number of read requests to the second storage device per unit time, to calculate a value indicative of the number of read requests in a case of the maximum response time;
calculating based on the calculated value indicative of the number of read requests and on the number of the memory areas in the second storage device, an upper limit value of the number of read requests to a memory area per unit time; and
outputting the calculated upper limit value.

2. The non-transitory computer-readable recording medium according to claim 1, the load threshold calculating process further comprising calculating based on the calculated value indicative of the number of read requests and on a ratio of the number of read requests to the number of access requests to the second storage device per unit time, a value indicative of the number of access requests in a case of the maximum response time, wherein
the calculating of the upper limit value is executed to calculate based on the calculated value indicative of the number of access requests and on number of the memory areas in the second storage device, an upper limit value of the number of access requests to a memory area per unit time.

3. The non-transitory computer-readable recording medium according to claim 2, the load threshold calculating process further comprising calculating for each memory area in the second storage device and based on number of memory areas in each storage device of a group of storage devices including the first storage device and the second storage device and differing in response performance to the access request, a probability of issue of an access request to each memory area, wherein
the calculating of the upper limit value is executed to calculate based on sum of the calculated probabilities of issue of an access request to each memory area, on a maximum probability among the probabilities of issue of an access request to each memory area, and on the calculated number of access requests, an upper limit value of the number of access requests to the memory area per unit time.

4. The non-transitory computer-readable recording medium according to claim 1, the load threshold calculating process further comprising:
acquiring a response time of the second storage device for response to the read request for a case where the number of process time slots overlapping each other per unit time for processing an access request to the second storage device is identical with the number of memory devices of the second storage device;
substituting the acquired response time into the response model to calculate a value indicative of the number of read requests in a case of the response time;
calculating based on the calculated value indicative of the number of read requests and on the number of memory areas in the second storage device, a lower limit value of the number of read requests to a memory area in the first storage device per unit time; and
outputting the calculated lower limit value.

5. The non-transitory computer-readable recording medium according to claim 4, causing the computer to execute a load threshold calculating process of calculating based on a value indicative of the number of read requests in a case of the response time and on a ratio of the number of read requests to the number of access requests to the second storage device per unit time, a value indicative of the number of access requests in a case of the response time, wherein
the load threshold calculating process of calculating the lower limit value is executed to calculate based on the value indicative of the number of access requests in the case of the response time and on the number of memory areas in the second storage device, a lower limit value for the number of access requests to a memory area in the first memory device per unit time.

6. The non-transitory computer-readable recording medium according to claim 5, the load threshold calculating process further comprising calculating for each memory area in the second storage device and based on the number of memory areas in each storage device of a group of storage devices including the first storage device and the second storage device and differing in response performance to the access request, a probability of issue of an access request to the memory area, wherein
the calculating of the lower limit value is executed to calculate based on a sum of the calculated probabilities of issue of an access request to each memory area, on a maximum probability among the probabilities of issue of an access request to each memory area, and on a value indicative of the number of access requests in a case of the response time, a lower limit value of the number of access requests to a memory area in the first storage device per unit time.

7. The non-transitory computer-readable recording medium according to claim 2, wherein
the calculating of the upper limit value is executed to calculate an upper limit value of the number of access requests to a memory area in the first storage device per unit time, by dividing a value indicative of the number of access requests in a case of the maximum response time by number of the memory areas in the second storage device.

8. The non-transitory computer-readable recording medium according to claim 5, wherein
the calculating of the lower limit value is executed to calculate a lower limit value of the number of access requests to a memory area in the first storage device per unit time, by dividing a value indicative of the number of access requests in a case of the response time by number of the memory areas in the second storage device.

9. The non-transitory computer-readable recording medium according to claim 4, the load threshold calculating process further comprising:
acquiring the number of access requests, per unit time, to each memory area allotted from a group of storage devices as a data storage destination, the group of storage devices including the first storage device and the second storage device and differing in response performance to the access request;
calculating based on the acquired number of access requests to the each memory area per unit time and on the calculated upper limit value and/or the lower limit value, the number of memory areas allotted from each storage device of the group of storage devices as the data storage destination;
calculating based on the calculated number of memory areas allotted from the each storage device and on a memory capacity of the memory areas, a capacity ratio representing a ratio of a memory capacity of the memory area allotted from the each storage device to a memory capacity of the memory area allotted from the group of storage devices as the data storage destination; and
outputting the calculated capacity ratio.

10. The non-transitory computer-readable recording medium according to claim 9, the load threshold calculating process further comprising:
calculating a sum of the number of access requests, per unit time, to a memory area allotted from any given storage device among the group of storage devices;
substituting the calculated sum of the number of access requests into the response model, to calculate for the given storage device, a response time for response to a read request; and
outputting the calculated response time.

11. The non-transitory computer-readable recording medium according to claim 1, the load threshold calculating process further comprising:
acquiring the number of access requests per unit time to any one memory area allotted from the second storage device; and
changing an allotment destination of the one memory area from the second storage device to the first storage device when the acquired number of access requests is greater than the upper limit value.

12. The non-transitory computer-readable recording medium according to claim 4, the load threshold calculating process further comprising:
acquiring number of access requests, per unit time, to an arbitrary memory area allotted from the first storage device; and
changing the allotment destination of the arbitrary memory area from the first storage device to the second storage device when the acquired number of access requests is less than the lower limit value.

13. A load threshold calculating apparatus comprising:
an acquiring unit that acquires for a second storage device, a required maximum response time for response to a read request, the second storage device having a lower response performance to an access request that represents a read request or write request than a first storage device;
a substituting unit that substitutes the acquired maximum response time into a response model expressing for the second storage device, a response time for response to the read request, the response time increasing exponentially with an increase in the number of read requests and according to an exponent denoting the number of read requests to the second storage device per unit time, to calculate a value indicative of the number of read requests in a case of the maximum response time;
a calculating unit that calculates based on the calculated value indicative of the number of read requests and on the number of the memory areas in the second storage device, an upper limit value of the number of read requests to a memory area per unit time; and
an output unit that outputs the calculated upper limit value.

14. A load threshold calculating method executed by a computer, the load threshold calculating method comprising:
acquiring for a second storage device, a required maximum response time for response to a read request, the second storage device having a lower response performance to an access request that represents a read request or write request than a first storage device;
substituting the acquired maximum response time into a response model expressing for the second storage device, a response time for response to the read request, the response time increasing exponentially with an increase in the number of read requests and according to an exponent denoting the number of read requests to the second storage device per unit time, to calculate a value indicative of the number of read requests in a case of the maximum response time;
calculating based on the calculated value indicative of the number of read requests and on the number of the memory areas in the second storage device, an upper limit value of the number of read requests to a memory area per unit time; and
outputting the calculated upper limit value.
